(19) United States
(12) Patent Application Publication
(10) Pub. No.: US 2026/0369120 A1
(43) Pub. Date: Nov. 19, 2026

(54) ROBOTIC CHEF INCORPORATING FEEDER STATION, COOKING STATION, AND TRANSPORT SYSTEM INCLUDING ACTUATOR FOR OPENING AND CLOSING THE FEEDERS

(71) Applicants: Yissum Research Development Company of the Hebrew University of Jerusalem Ltd., Jerusalem (IL); SAVOREAT LTD., Rehovot (IL)

(72) Inventors: Shai SULTAN, Ganey Tal (IL); Dor JACOBI, Kibbutz Dvir (IL); Yoni SIN REUVEN, Rehovot (IL); Oded SHOSEYOV, Shoham (IL); Ido BRASLAVSKY, Ness Ziona (IL)

(73) Assignees: Yissum Research Development Company of the Hebrew University of Jerusalem Ltd., Jerusalem (IL); SAVOREAT LTD., Rehovot (IL)

(21) Appl. No.: 19/147,890

(22) PCT Filed: Jan. 16, 2024
(86) PCT No.: PCT/IL2024/050064

§ 371 Date: Jul. 14, 2025

Related U.S. Application Data
(60) Provisional application No. 63/480,184, filed on Jan. 17, 2023.
(60) Provisional application No. 63/480,193, filed on Jan. 17, 2023.
(60) Provisional application No. 63/480,198, filed on Jan. 17, 2023.

(51) Int. Cl. G07F 17/00; A47J 44/00

(52) U.S. Cl. CPC G07F 17/0078; A47J 44/00

(57) ABSTRACT

A robotic chef includes a feeder station, each feeder comprising a dispensing outlet and configured to dispense a raw food material; one or more cookers adapted for shaping and cooking the raw food material, wherein the cooking station is axially above or below the feeder station; a lift with a platform; and a controller. The controller controls movement of the platform between a loading position, in which the platform is below a dispensing outlet of a feeder, to thereby receive the raw food material, and a discharge position in which the platform is adjacent to a cooking surface of a cooker. Each feeder includes a knife having an outlet cover that is moveable between a closed state, in which the outlet cover covers the dispensing outlet, and an open state. The lift includes an actuator for displacing the outlet cover from the closed state to the open state.

### RELATED APPLICATIONS

This Application claims priority to U.S. Provisional Patent Application No. 63/480,184, entitled “A Feeder Unit and System Comprising Same,” filed Jan. 17, 2023, U.S. Provisional Patent Application No. 63/480,193, filed Jan. 17, 2023, entitled “Cooking Apparatus,” and U.S. Provisional Patent Application No. 63/480,198, filed Jan. 17, 2023, entitled “System for Food Manufacturing and Management,” the contents of each of which are hereby incorporated by reference as if fully set forth herein.

### TECHNOLOGICAL FIELD

The present disclosure generally discloses a robotic chef, and more specifically, but not exclusively, to a robotic chef including a feeder station for dispensing raw food, a cooking station for cooking the food, and a transport system for transporting raw food between the feeders and the cookers that also includes an actuator for opening and closing the feeders.

### BACKGROUND OF THE INVENTION

Among processed foods, hamburgers and other flat products such as pancakes, shrimp, or chicken nuggets, enjoy considerable popularity. Hamburgers and other flat foods are typically processed through a series of steps including heating, optionally flipping, and packaging. Typically, each of these steps is handled manually. Production of hamburgers and other flat food products exhibit a low degree of automation, and thus hamburger production lines are typically time consuming and require manual labor.

In order to render hamburger production more efficient and cost effective, while ensuring that the patties are fully cooked and while maintaining high sanitary conditions, automated systems for patty manufacturing and cooking are desired.

Recently, some robotic chefs have been developed for cooking and delivery of hamburgers or vegetarian hamburger-like patties. For example, U.S. Patent Publication 2023/0274603 discloses a robotic apparatus that separately heats a hamburger bun, heats a hamburger, and places the hamburger and bun within a box to vend to a consumer. International Patent Publication WO2022/144844, which is assigned to the same assignee as the present application, discloses a system for custom preparation of a hamburger or hamburger-like patty, including a cooking space defined between a bottom heating surface and a top heating surface, and a lift that is configured to raise and lower the top heating surface relative to the bottom heating surface.

One universal requirement for any robotic chef is a transport system for delivering raw food materials from a raw food storage area to a cooking area. Many different strategies have been implemented for such transportation. These strategies are influenced, inter alia, by the types of ingredients that are used (solid, liquid, paste-like), by the type of cooking that is performed (heating in a pot, baking in an oven, etc.), and by the relative locations of the food storage area and the cooking area (one above the other, side by side, etc.).

Some robotic chef layouts incorporate a food storage area above a cooking area. For such layout, one common transport strategy is to orient ingredient containers in a line, run a receptacle for the various ingredients on a track below the ingredient containers, dispense each of the ingredients to the receptacle, and then lower the ingredients from the receptacle to the cooking area. For example, International Patent Publication WO2022/144844 discloses, in one embodiment, a plurality of canisters arranged colinearly, and a deposition surface that is movable in three dimensions (x, y, z). Ingredients may be deposited from each of the canisters onto the deposition surface, and the deposition surface may then be transferred to the heating assembly. The specific manner of delivering the ingredients from the deposition surface to the heating assembly is not disclosed. In another example, U.S. Pat. No. 10,154,762 discloses, in one embodiment, a plurality of ingredient dispensing modules arranged in a row. A linear sliding transfer assembly includes, mounted thereon, a sliding transfer cup. The cup is rotatable around an axis of the sliding transfer assembly. In order to transfer ingredients from the dispensing modules to a cooking pot, a belt drive is actuated to slide the cup, sequentially, below each ingredient module. After the cup is full, the cup is rotated so as to dump its contents into a cooking pot below.

### SUMMARY OF THE INVENTION

Many robotic chefs take up an inordinate amount of space for performing particular functions, rendering them less attractive. For example, many robotic chefs include multiple duplicative actuators for performing similar functions. In the references cited above, each of the food dispensing units has its own dispensing actuator. These separate actuators are useful in order to enable metered dosage of different ingredients, but they require additional space. In another example, typical prior art mechanisms for robotic chefs having top and bottom heaters require (at least) two separate drive mechanisms within a cooking station—one (or more) for transporting raw food in and out of a cooking space, and a second one for controlling a height of the cooking space. The utilization of different drive mechanisms for different movements is understandable, but also comes at the expense of additional space.

Transportation of dispensed food ingredients from food storage areas to cooking areas also requires dedication of significant space. Known mechanisms for transporting raw food ingredients to a cooking area, such as those delineated above, utilize dedicated mechanical components, such as receptacles and tracks. These dedicated mechanical components are used exclusively for transporting, and are not used at all for other functions of the robotic chef, such as food dispensing and cooking.

Furthermore, many of the transport mechanisms described above are useful only for transporting certain types of ingredients. For example, a transport mechanism involving tilting a mixing bowl into a cooking pot is practical for liquid and solid ingredients, but is less applicable for viscous pastes, which may adhere to the mixing bowl.

In addition, robotic chefs are generally configured to prepare a single portion at a time. This is especially the case for known robotic chefs for preparation of patties, hamburgers, or hamburger-like substances. In contrast to a human cook, who is able to use the same grill to prepare multiple hamburgers simultaneously, a typical prior art robotic chef is limited to preparing one hamburger at a time. This limitation has obvious drawbacks. Increasing throughput requires installation of multiple robotic chefs, which, in turn, requires significant capital and additional dedication of space.

The present disclosure addresses these and other drawbacks of known robotic chefs, by disclosing a highly compact and efficient robotic chef. The robotic chef may particularly be used to prepare and cook patty-like products, such as hamburgers, hash browns, shrimp substitutes, or any other meat-based or vegetable-based patty-like food products. In its most general aspect, the disclosure provides a robotic chef which comprises a feeder station comprising one or two or more feeder stations, each being configured and operable for depositing an amount of a raw food material, a lift platform that is configured to receive the amount of the raw food material from each one of the feeder stations (and optionally weigh the amount of the raw food material using an integrated weight measurement device such as a load cell) and move the raw food material to a cooking station comprising one or more cookers adapted for shaping and cooking the raw food material. When the system comprises two or more cookers, the two or more cookers share a common power drive.

The robotic chef specifically includes a transport system for transferring dispensed ingredients from the feeder station to the cooking station. This transport system is integrated with components of both the feeder station and the cooking station.

In particular, the transport system includes a platform which is movable in at least two dimensions with a lift. The platform includes an actuator, formed integral with the platform, for opening and closing food storage receptacles that dispense food ingredients to the platform. When multiple receptacles are arranged in a colinear array, the actuator is configured to open and close each of the food storage receptacles in the array. A track is configured below dispensing outlets of the food storage receptacles in the array. The platform is movable on the track, so as to enable access to the multiple food storage receptacles in the array.

In some embodiments, the robotic chef is oriented with a feeding station above a cooker station. The feeding station contains raw ingredients in individual feeders and a mechanism for dispensing the raw ingredients onto the platform. The cooking station includes mechanisms for dragging the raw food from the platform to a cooking space between a top and bottom oven, lowering the top oven over the food, cooking the food, and dragging the cooked food to a prepared food drawer. The platform of the transport system may have substantially the same width as the bottom oven and the prepared food drawer. Advantageously, the same dragger may be used to deliver raw food from the platform to the cooker and to dispense cooked food from the cooker to the drawer. This setup also enables the platform to be movable only in two dimensions, because the dragger performs all necessary movements in the third dimension.

In some embodiments, the robotic chef includes multiple feeders arranged colinearly, above multiple cookers also arranged colinearly. Each of the colinear feeders is actuated by a single actuator, and mechanical movements of all of the cookers are actuated by a single belt drive. The transport system is configured to receive raw food ingredients from one or more of the feeders, and to deliver the ingredients to a respective cooker for cooking. Advantageously, the robotic chef is thus able to achieve a very high throughput while occupying a minimum of space.

Typically, the cooking station is operated and maintained during a cooking session at a temperature between 100 and 200 °C while the feeding station is typically maintained at sub-zero or low temperatures ranging between 2 and 5 °C. Despite the known tendency of heat to rise and to transfer from a hot object to a cold object, in one implementation, the hotter cooking station is provided at a region below the cooler feeder station. Placing the cooking station below the feeder station enables the robotic chef to be positioned on a countertop, with the prepared food drawer easily accessible to a consumer.

The robotic chef also includes an exhaust mechanism for the cooking station. In embodiments with multiple colinear cookers, the exhaust mechanism includes a transverse exhaust pipe configured to receive exhaust from each oven, and a peripheral vertical exhaust pipe for delivering the exhaust to outside the robotic chef. The exhaust is segregated and insulated from the electronics and from the cooling system for the feeder station.

The robotic chef may be equipped with a controller that is configured for receiving data signals corresponding with parameters of one or more of the cooking space drive mechanisms, the dragger drive mechanism, and the transport system, weight of a food item placed over the lift platform, temperature of the top heater and the bottom heater, and optionally temperature of the product undergoing cooking. The controller is set to generate command signals to control operation of one or more of the cooking space drive mechanisms, dragger drive mechanisms, the transport system, the temperature of the bottom heater, and the temperature of the top heater.

The robotic chef disclosed herein is particularly well-suited for preparation of patties from paste-like materials, according to user preference. The user may input an order with a desired makeup of a patty and desired cooking instructions. Based on the user input, the controller instructs an actuator of the feeder station to deliver each of the ingredients of the patty to the platform, in sequence. The platform is then lowered to the cooking station. Specifically, the platform moves into a flush or immediately adjacent position to a top surface of the bottom heater tray. The dragger displaces the uncooked food item from the platform onto a top surface of the bottom heater of the cooker. Following the cooking, the dragger drags the completed patty to the prepared food drawer. As each patty is cooking in a respective cooking space, the platform and feeder may be used to process the next patty order.

Typically, the number of feeder stations and cooker mechanisms may be greater than one and is selected to allow continuous production of food products. In most general terms, for providing a continuous production, material deposition, material shaping and cooking must occur simultaneously and continuously, such that when one food product is being cooked, another food product is being deposited onto the platform and transferred to an available cooker. Thus, in some embodiments, the feeder station may comprise two or more feeders and the cooking station may comprise two or more cookers. In some embodiments, the feeder station may comprise 2, 3, 4, 5, 6, or more feeders, each being configured for depositing a different food material or food component. Independently, the cooking station may comprise 2, 3, 4, 5, 6, or more cookers.

In particular embodiments, according to a first aspect, a robotic chef includes a feeder station comprising one or more feeders, each feeder comprising a dispensing outlet and configured to dispense an amount of a raw food material; a cooking station comprising one or more cookers adapted for shaping and cooking the raw food material, wherein the cooking station is axially above or axially below the feeder station; a lift configured with a raw food platform; and a controller. The controller is configured to control movement of the raw food platform axially between a loading position, in which the platform is provided below a dispensing outlet of a respective feeder, to thereby receive an amount of the raw food material, and a discharge position in which the platform is adjacent to a cooking surface of a respective cooker, to enable discharging the raw food material onto a region of said cooking surface.

Optionally, the feeder station comprises at least two feeders arranged in a coplanar array, and the cooking station comprises at least two cookers arranged in a coplanar array, and the lift comprises a horizontal track. The lift is configured to receive raw food material from any feeder in the feeder array and to deliver the raw material to any cooker in the cooker array.

Each feeder may include a horizontally displaceable knife. The knife comprises an outlet cover that is moveable between a closed state, in which the outlet cover covers the dispensing outlet, and an open state, in which the outlet cover does not cover the dispensing outlet.

The lift may include an actuator for displacing the outlet cover from the closed state to the open state. Optionally, when the outlet cover returns from the open state to the closed state, and raw food material is extending from the dispensing outlet, the outlet cover is configured to slice the raw food material and separate said raw food material from the dispensing outlet. Optionally, the knife is spring-biased toward the closed state.

The actuator may include a slot configured on the lift axially above the platform, and the knife may include a protruding tab that is axially below the outlet cover and horizontally displaced relative to the dispensing outlet. The slot is sized to engage the tab. When the slot is engaged with the tab, horizontal movement of the platform in a first direction causes displacing of the outlet cover from the outlet, and horizontal movement of the platform in an opposite direction, following dispensing of a paste-like raw food material from the dispensing outlet, causes cutting of the paste-like raw food material from the dispensing outlet onto the platform and closing of the dispensing outlet with the outlet cover.

In advantageous implementations, the feeder station comprises at least two feeders arranged in a coplanar array, and the actuator comprises two parallel slots configured to engage the tab. The controller is configured to select one of the two parallel slots to engage the tab such that opening of the dispensing outlet occurs through a movement of the platform toward a periphery of the array. Selection of this slot and movement toward the periphery of the array helps enable full use of the horizontal extent of the array for opening dispensing outlets.

In another implementation according to the first aspect, each cooker comprises a dragger configured to drag the raw food material from the platform to a cooking surface of a respective cooker. The dragger may include a dragger surface mounted on two parallel arms, wherein the parallel arms define a space therebetween that is sized to permit a top heater of the cooker to pass therebetween, and a space underneath to enable the raw food material to pass underneath when the platform is moved laterally relative to the dragger. The dragger surface, platform, and cooking surface may be approximately the same width, so that the dragger is configured to drag all of the raw food material deposited onto the raw food platform onto a respective cooking surface.

The robotic chef may further include an exhaust for venting hot air from the cooking station. Optionally, the cooking station comprises a plurality of cookers arranged in a coplanar array, and the exhaust comprises a shared exhaust pipe for each of the plurality of cookers. The shared exhaust pipe comprises: a horizontal section that increases in cross sectional area from a first end of the coplanar array to a second end of the coplanar array; and a vertical section extending from the second end of the coplanar array to a top of the robotic chef.

Optionally, the feeder station is configured within a cooling zone for maintaining the raw food product ingredients cool. The lift and platform are outside the cooling zone.

The platform may include one or more load cells configured to measure a weight of dispensed raw food product.

According to a second aspect, a method of preparing a food product with the robotic chef is disclosed. The method includes: receiving a user instruction regarding composition of a food product; actuating the lift so as to place the platform in a loading position beneath at least one feeder; dispensing raw food material from the at least one feeder; delivering the platform from the loading position to the discharge position in which the platform is adjacent to a cooking surface of a respective cooker, to enable discharging the raw food material onto a region of the cooking surface; cooking the raw food product in the cooker; and dispensing the cooked food product from the cooker station to a cooked food drawer.

Optionally, each feeder includes a horizontally displaceable knife, wherein the knife comprises an outlet cover that is moveable between a closed state, in which the outlet cover covers the dispensing outlet, and an open state, in which the outlet cover does not cover the dispensing outlet, and wherein the lift includes an actuator for displacing the outlet cover from the closed state to the open state. The dispensing step further includes: actuating the outlet cover from the closed state to the open state; dispensing the raw food material from the at least one feeder in the open state; and returning the outlet cover from the open state to the closed state. In such implementations, when raw food material is extending from the dispensing outlet, the returning step comprises slicing the raw food material and separating said raw food material from the dispensing outlet.

Optionally, the actuator comprises a slot configured on the lift axially above the platform, and the knife comprises a protruding tab that is axially below the outlet cover and horizontally displaced relative to the dispensing outlet. The slot is sized to engage the tab. The step of actuating the outlet cover comprises engaging the slot with the tab and horizontally moving the platform in a first direction to thereby cause displacing of the outlet cover from the outlet, and the step of returning the outlet cover comprises horizontally moving of the platform in an opposite direction, following dispensing of the paste-like raw food material from the dispensing outlet, to thereby cut the paste-like raw food substance from the dispensing outlet onto the platform and close of the dispensing outlet with the outlet cover.

Optionally, the feeder station includes at least two feeders arranged in a coplanar array, and wherein the actuator comprises two parallel slots configured to engage the tab. The method further comprises selecting one of the two parallel slots to engage the tab such that opening of the dispensing outlet occurs through a movement of the platform toward a periphery of the array.

Further advantageous implementations of the feeder station, the cooker station, the mechanisms of operation of the feeder station and the cooker station, the transport system between the feeder station and the cooker station, and the overall structure of the robotic chef, will be described in detail further herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a left front perspective view of a robotic chef, according to embodiments of the present disclosure;

FIG. 2 is a right front perspective view of the robotic chef of FIG. 1, according to embodiments of the present disclosure;

FIG. 3 is a schematic cross section view of the robotic chef of FIG. 1, showing different modules thereof;

FIG. 4A is a left front perspective view of the robotic chef, with certain exterior walls removed;

FIG. 4B is a right rear perspective view of the robotic chef, with certain exterior walls removed;

FIG. 5A illustrates a lift mechanism, according to embodiments of the present disclosure;

FIG. 5B illustrates a close-up view of the platform of the lift mechanism of FIG. 5A;

FIG. 6A depicts a perspective view of a feeder, according to embodiments of the present disclosure;

FIG. 6B depicts a cross section view of the feeder of FIG. 6A;

FIG. 7 provides a close-up view of an actuator mechanism of the feeder, according to embodiments of the present disclosure;

FIG. 8 is a cross-section view of the actuator, according to embodiments of the present disclosure;

FIG. 9A is a zoom-in view of a first embodiment of an interface between the piston and the tubular body of the actuator;

FIG. 9B is a zoom-in view of a second embodiment of an interface between the piston and the tubular body of the actuator;

FIG. 10 is a zoom-in view of the dispensing end of the receiving tubular body, according to embodiments of the present disclosure;

FIGS. 11A-11C illustrate a progression of views as the actuator dispenses a paste-like material from the feeder, according to embodiments of the present disclosure;

FIG. 12 illustrates an array of feeders arranged colinearly, according to embodiments of the present disclosure;

FIG. 13 illustrates a crank shaft unit for the array of feeders of FIG. 12, according to some embodiments of the invention;

FIG. 14A and FIG. 14B depict a process of removal and replacement of a raw food container from one of the feeders of the array of FIG. 12;

FIG. 15A illustrates an array of knives, according to embodiments of the present disclosure;

FIG. 15B illustrates an individual knife, according to embodiments of the present disclosure;

FIGS. 16A-16C illustrate a second embodiment of an array of knives;

FIG. 17 illustrates an array of knives oriented below an array of outlets of feeders, according to embodiments of the present disclosure;

FIG. 18 illustrates the direction of opening of different knives in the array of FIG. 17;

FIGS. 19A-19H illustrate steps in opening of a feeder and dispensing of a raw food material from the feeder to the platform, according to embodiments of the present disclosure;

FIG. 20A depicts a front upper perspective view of a cooker system, according to embodiments of the present disclosure;

FIG. 20B depicts a rear upper perspective view of the cooker system of FIG. 20A, according to embodiments of the present disclosure;

FIG. 21 depicts a single cooker of the cooker system of FIGS. 20A and 20B, according to embodiments of the present disclosure;

FIG. 22 is a side view of the dragger and cooking space of a single cooker, according to embodiments of the present disclosure;

FIG. 23A illustrates the integrated drive system of the cooker system, according to embodiments of the present disclosure;

FIG. 23B is a close up view of a clutch of the integrated drive system;

FIGS. 24A-24C illustrate sequential movement of the dragger and the cooking space during preparation of a food item, according to embodiments of the present disclosure;

FIG. 25 illustrates a lift tray for delivering a raw food product with the cooker system, according to embodiments of the present disclosure;

FIG. 26 illustrates exhaust piping and a flow of hot air from the cooking station, according to embodiments of the present disclosure;

FIG. 27 illustrates a cooling system of the robotic chef, according to embodiments of the present disclosure;

FIGS. 28A and 28B illustrate different regions of the cooling system of FIG. 27;

FIGS. 29A and 29B illustrate paths of hot air and cold air in the cooling system of FIG. 27; and

FIG. 30 illustrates steps in a method of preparing a food product, according to embodiments of the present disclosure.

### DETAILED DESCRIPTION OF EMBODIMENTS

The present disclosure generally discloses a robotic chef, and more specifically, but not exclusively, to a robotic chef including a feeder station for dispensing raw food, a cooking station for cooking the food, and a transport system for transporting raw food between the feeders and the cookers that also includes an actuator for opening and closing the feeders.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

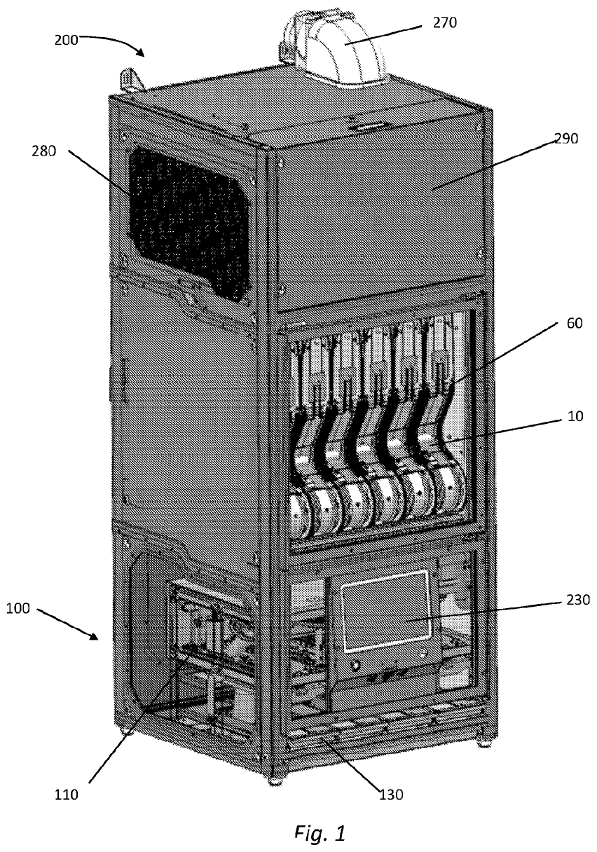

Referring to FIG. 1, robotic chef 200 includes feeder station 60, which includes multiple feeders 10 arranged linearly. Below the feeder station 10, cooking station 100 includes multiple cookers 110 arranged linearly, each having a prepared food tray 130. Above the feeder station 10 are cooling system 280, electrical box 290, and chimney 270. Input device 230 is arranged on a front face of the robotic chef 200, above the prepared food tray 130. The input device 230 may be, for example, a touch screen. Using the input device, the user may input an order for a prepared food product (e.g., specifying ingredients and size). The input device 230 is connected to a controller, which directs the various mechanical components of the robotic chef 200 to prepare the desired food product, as will be explicated further herein. The prepared food product is delivered to one of the prepared food trays 130, for the user to retrieve.

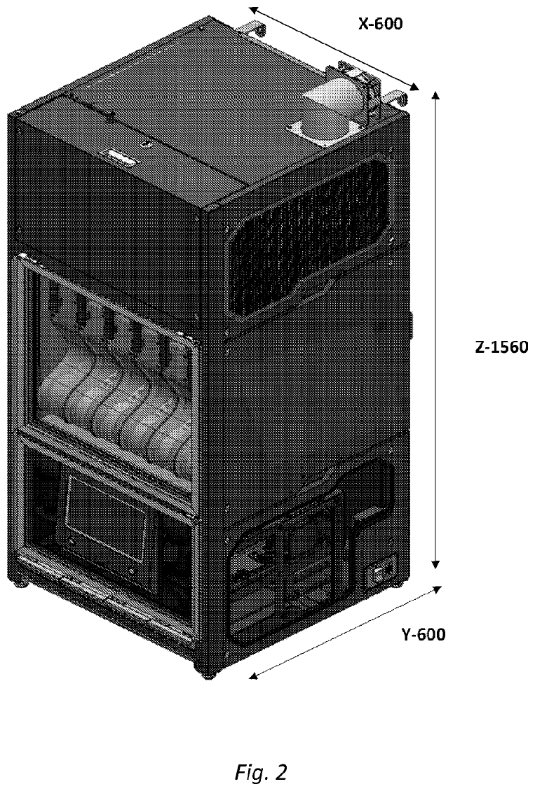

FIG. 2 illustrates exemplary dimensions of the robotic chef 200. In the illustrated example, the robotic chef is a square, with 600 mm on each of the X and Y axes, and 1,560 mm tall on the Z-axis. Advantageously, this size enables the robotic chef 200 to fit on a countertop, such as in a cafeteria, suitable for vending.

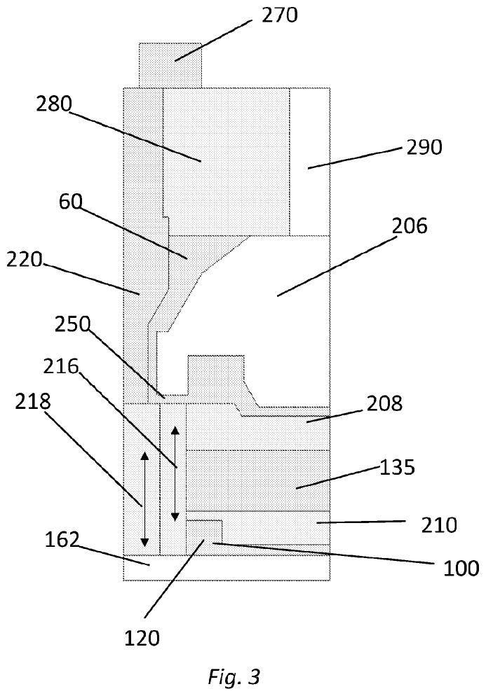

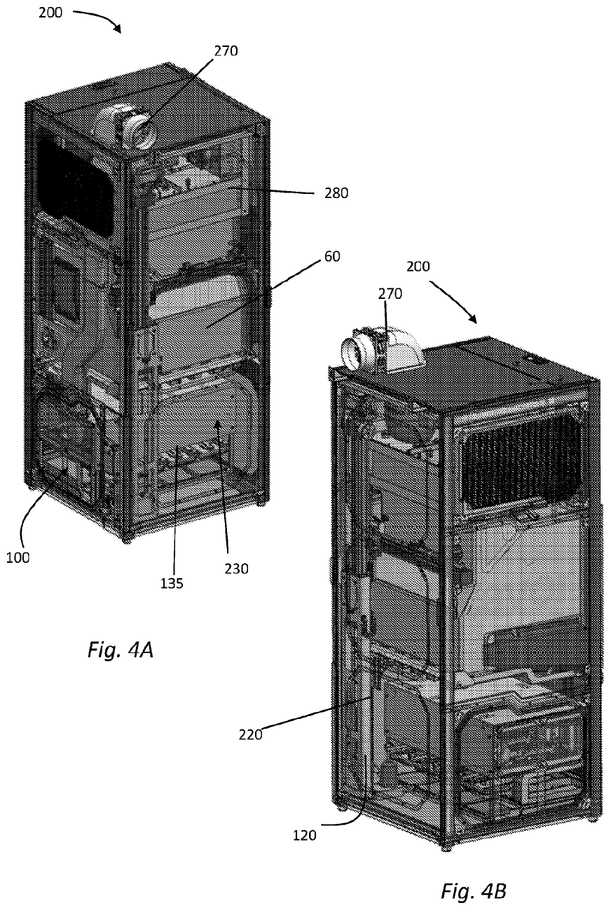

FIG. 3 schematically depicts a cross section view of robotic chef 200, illustrating the location of various components thereof. FIGS. 4A and 4B illustrate perspective views of the front and rear of the robotic chef 200, with certain parts rendered transparent to enable view of internal components. The “front” of the robotic chef 200 (i.e., the side with the input device 230) is on the right side of the view of FIG. 3, and is seen in FIG. 4A. The back of the robotic chef 200 is on the left side of the view of FIG. 3, and is seen in FIG. 4B.

Going from bottom to top, the cooking station 100 includes an oil tray 162 at a bottom portion thereof. The oil tray 162 is used to collect oil and other residue from the cooking station 100. The cooking station 100 includes at least one cooker defining a cooking space 120, and optionally includes at least two cookers arranged in a coplanar array. Above the cooking stations is an oven maintenance section 210. A user may access oven maintenance section 210 to remove and clean components of the cookers. Cooker drive unit 135 is above oven maintenance section 210. The cooker drive unit 135 is used for controlling movements within the cooking station 100.

Feeder station 60 is configured above the cooking station 100. Feeder station 60 includes at least one feeder, and optionally includes an array of feeders arranged linearly in a coplanar array. The feeder station 60 also defines a cooling volume 206, meaning, an area that is maintained refrigerated. Knife section 250 is configured below feeder station 60. Knife section 250 includes a plurality of knives configured to open and close outlet nozzles of the feeders, and to separate dispensed raw food material from the outlet nozzles of the feeders. A knife maintenance section 208 allows access to the knives, for the purpose of removal and cleaning.

In the illustrated embodiment, the cooking station 100 is axially below the feeder station 60. This configuration is advantageous, insofar as it enables the prepared food to be dispensed at waist level, when the robotic chef 200 is on a countertop. In alternative embodiments, the cooking station 100 may be axially above the feeder station 60.

Above the feeder station 60 are electrical cabinet 290, cooling system 280, and exhaust pipe 270, whose functions will be described further herein.

The lift system includes a gantry 220, which is located at a rear face of the robotic chef 200. The gantry 220 is attached to a leg configured to move upwards and downwards in the Z-axis on path 218, as well as from side to side along the X-axis (in and out of the plane of FIG. 3). The term “gantry” may be used herein to refer to the entire lift system. The leg carries a platform, which is used to transport raw food ingredients from the feeder station 60 to the cooking station 100. The platform travels up and down in the Z-axis on path 216, as well as side to side along the X-axis.

The robotic chef also includes a controller (not shown). The controller receives instructions from the user interface 230 and/or from a wireless connection (e.g., a software application on the user's mobile device) and displays messages to users via user interface 230 and/or the wireless connection. The controller includes a memory storing non-transitory computer readable instructions, and a processor for executing such instructions. In particular, the controller is configured to issue instructions to the various drives and heating sources used to operate the robotic chef 200.

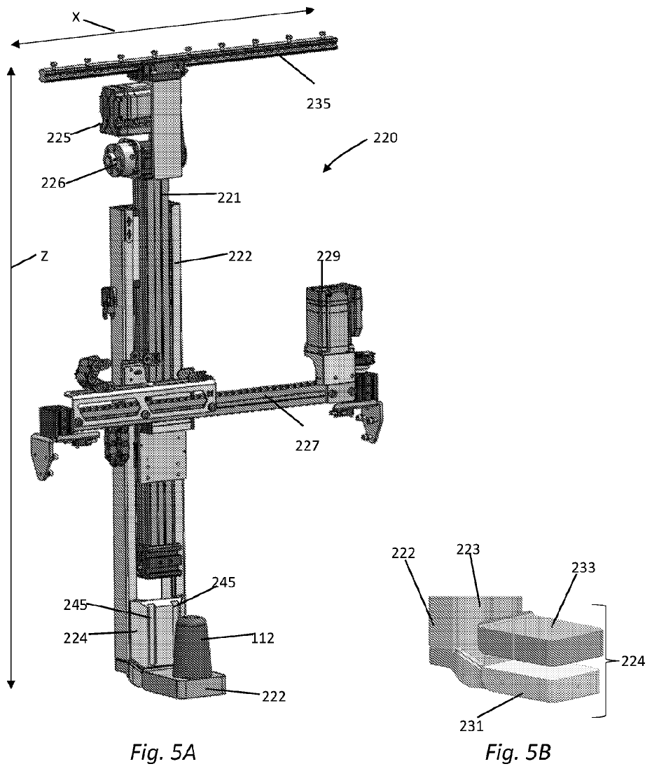

Referring now to FIG. 5A, the lift mechanism includes frame 221, Z-axis motor 225, and X-axis motor 229. The motors may be, for example, servo motors or stepper motors. The motors are configured to move a leg 222 in straight lines along the Z axis (up and down frame 221) or along the X axis (along horizontal track 227, with the horizontal movement stabilized by rail 235). The Z-motor 225 may be equipped with a brake 226, which may be engaged in order to hold the leg 222 in place, for example, during maintenance of the lift mechanism.

Raw food platform 224 is configured on the bottom of leg 222. As shown in FIG. 5B, platform 224 includes a removable plate 233. A load cell 231 is located underneath the plate 233. The load cell 231 may be used to measure weight of a raw food ingredient that is dispensed onto the platform 224.

Actuator 223 is attached to platform 224, and is generally configured perpendicular thereto. The actuator 223 includes two parallel slots 245. These slots 245 are used to engage with corresponding tabs of knives, in order to open and close dispensing outlets of feeders, as will be described further herein.

An advantage of having the lift mechanism include tracks for movement along both the X-axis and the Z-axis is that, when the feeder station comprises at least two feeders arranged in a coplanar array, and the cooking station comprises at least two cookers arranged in a coplanar array, the lift is configured to receive raw food material from any feeder in the feeder array and to deliver the raw material to any cooker in the cooker array.

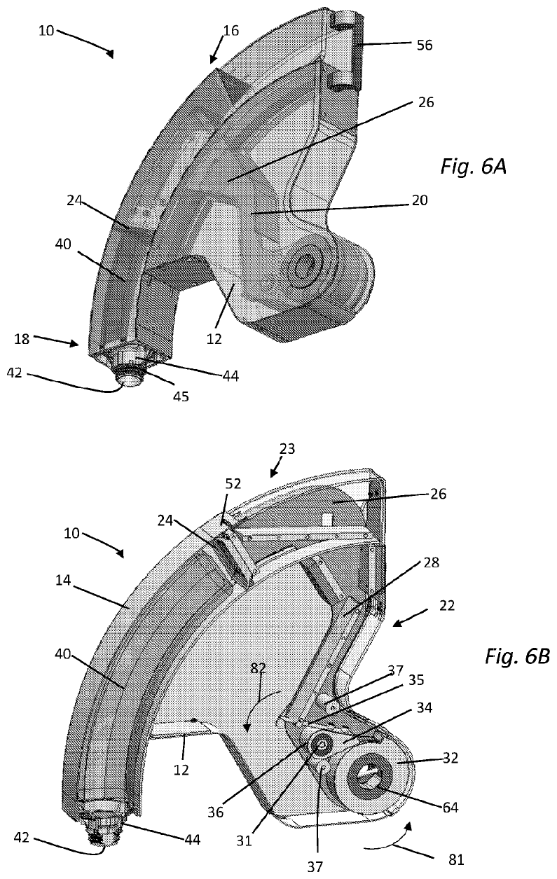

FIGS. 6A-14B illustrate operation of the feeder station.

As used in the present disclosure, the terms “feeder” and “feeder mechanism” are equivalent, and refer to a mechanical device used for storage and delivery of a metered amount of an ingredient from a receptacle. As used in the present disclosure, the terms “actuator” and “actuating mechanism” are equivalent, and refer to a mechanical component, or a series of mechanical components operating together, configured to dispense the metered amount of the ingredient from the feeder.

FIGS. 6A-B provide depictions of an embodiment of a feeder 10. Feeder 10 includes a receiving tubular body 14 with a back end 16 and a dispensing outlet 18. In the illustrated embodiment, the receiving tubular body 14 defines a radial or arc-shaped path. This arrangement is advantageous for ensuring that the feeder is compact. In the plane of movement, receiving tubular body 14 may have any suitable cross-section, such as cylindrical, spherical, square, rectangular, or polygonal.

Removable container 40 is optionally insertable into the feeder 10. Container 40 may contain a raw food ingredient, such as a paste-like substance. The container 40 may be a flexible sleeve. Container 40 includes a dispensing nozzle 42 that is configured to true position articulation (i.e., may be aligned and fixed) relative to opening 45 of a dispensing cap 44 of the dispensing outlet 18. The dispensing cap 44 may be removably fixed within the dispensing outlet 18 through any suitable mechanism, such as a snap-fit mechanism. When the flexible sleeve of the container 40 is compressed, the increase in pressure causes dispensing of the contents of the container 40 through dispensing nozzle 42. Feeder 10 further includes a handle 56. The handle is used during the process of removing and replacing containers 40, as will be described further herein. The use of a container 40 is desirable for purposes of easy replacement and cleaning, as well as for ensuring that the raw food ingredient does not spread to other parts of the feeder 10.

Feeder 10 further includes a piston 20 that is coaxially displaceable within the receiving tubular body 14. Piston 20 includes outer walls 26. In the illustrated embodiment, the outer walls 26 comprise parallel plates that are held together, inter alia, by pins 37. Alternatively, the piston 20 may be partially or entirely solid. The outer walls 26 define an elevational region 22, extending vertically in the view of FIG. 6B, and a pushing region 23, extending horizontally in the view of FIG. 6B. In the illustrated embodiment, the outer walls 26 of the elevational region 22 and pushing region 23 are formed of integral pieces. The elevational region 22 may be substantially s-shaped, as depicted, or otherwise curved or linear. The pushing region 23 is formed at an angle to the elevational region 22. Advantageously, this configuration of the elevational region 22 and pushing region 23 enables a rotational force that is applied to the bottom of the elevational region 22 to be transferred to the push plate 24, as will be described further herein.

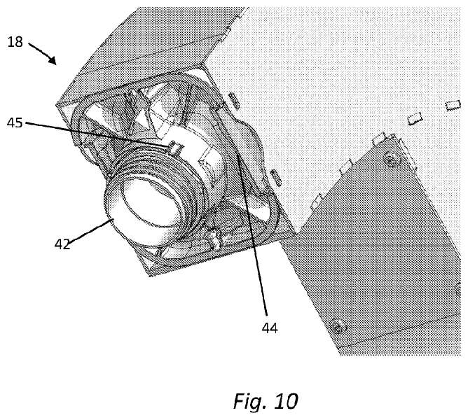

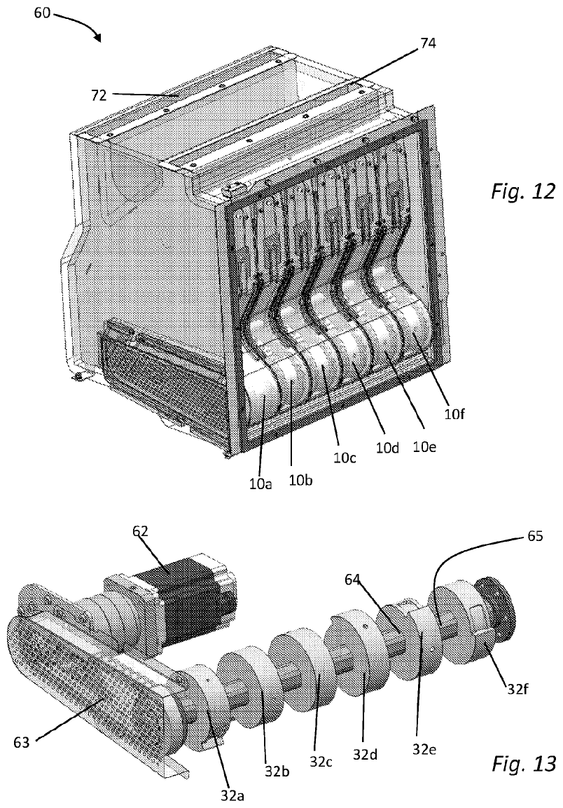

An actuator is configured for displacing the piston 20 in a metered increment within the tubular body 14, to thereby discharge the raw food ingredient from the tubular body 14. The actuator displaces the piston 20 between a retracted position, at which the push plate 24 is near the back end 16 of the receiving tubular body 14, and a discharged position at which the push plate 24 is near the dispensing outlet 18 of the receiving tubular body 14. The push plate 24 is snugly displaceable within the receiving tubular body 14. Optionally, a molded piece 25 (shown in FIG. 9A) is attached to the front of push plate 24, to distribute the force generated by push plate 24 toward edges of the receiving tubular body 14. Because the receiving tubular body 14 has an arc-shaped cross-section, the push plate 24 coaxially displaces within the receiving tubular body 14 along a radial path. In exemplary embodiments, the radial path defines an arc between a minimal path (slightly above 0 degrees) and 60 degrees. In the illustrated embodiment, the arc defines a radial path of 60 degrees. The length of the radial path may be influenced by the number of feeders 10 that are arranged in a colinear array, in which the sum total of the radial paths of all the feeders in the array cannot exceed 360 degrees, as will be discussed further herein. As the push plate 24 displaces, the elevational region 22 of the piston 20 correspondingly radially displaces within internal space 12 of feeder 10. The progression of displacement of the push plate 24 and elevational region 22 is shown in FIGS. 11A-11C. In FIG. 11A, the piston 20 is in a position of maximal retraction. In FIG. 11B, the piston 20 has displaced approximately half the volume of the receiving tubular body 14, and in FIG. 11C, the piston 20 has displaced the entire volume of the receiving tubular body 14.

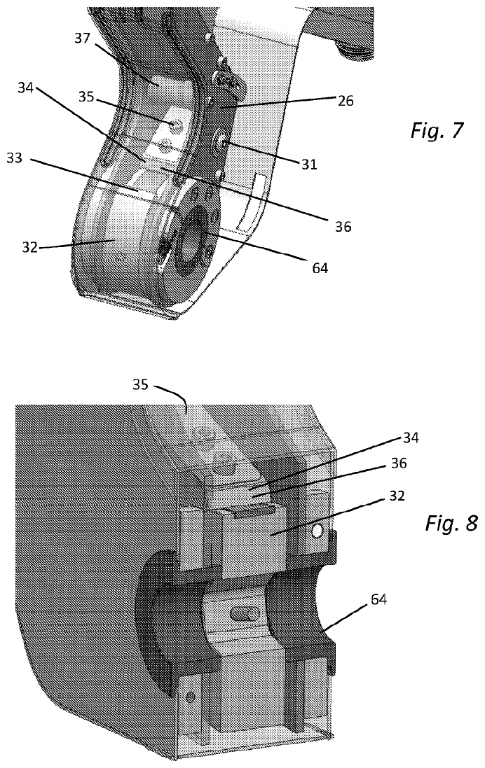

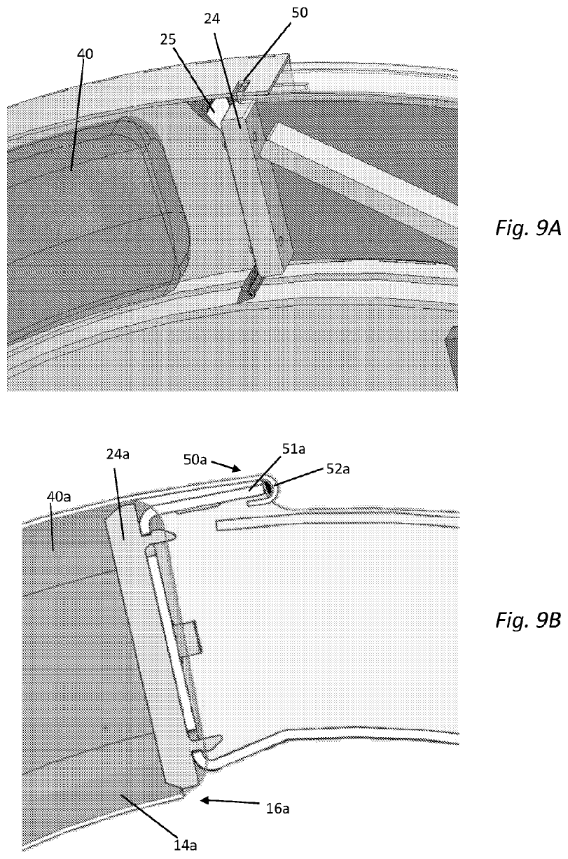

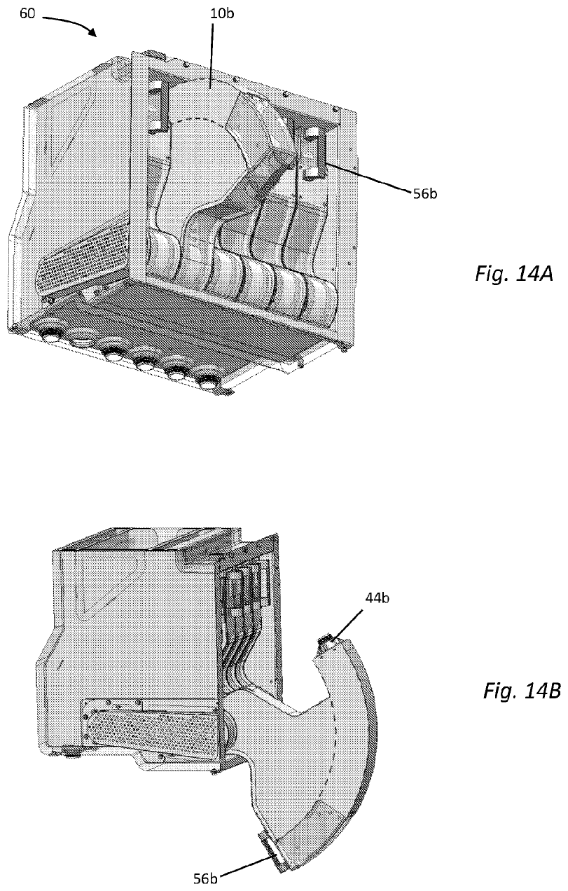

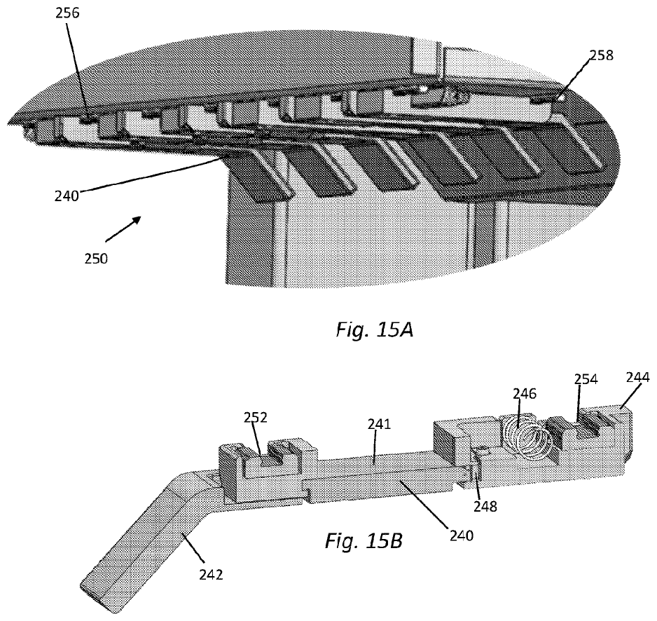

FIG. 7 illustrates a close-up view of the actuating mechanism, and FIG. 8 illustrates a cross-section view of certain elements of the actuating mechanism. In the illustrated embodiments, the actuating mechanism includes a cam and follower mechanism. Cam 32 has a snail shape (also known as a drop shape), including an inner radius, an outer radius, and a leading face 33 between the inner radius and the outer radius. The cam is rotatable through rotation of rings 64, which are secured around a camshaft. One exemplary camshaft will be described further herein in connection with FIGS. 12 and 13. The follower 36 is a latch that is configured to be actuated through movement of the cam 32, as will be described further herein. In the illustrated embodiment, follower 36 is teardrop shaped. The tip 34 of the tear drop has approximately the same dimensions as the leading face 33 of cam 32. In addition to being actuatable by the cam 32, follower 36 is articulated with the piston 20. In the embodiment illustrated here, rod 31 passes through both follower 36 and the outer walls 26 of piston 20, and thus rod 31 translates radial force from the follower 36 to the piston 20. Rod 31 is secured to the piston 20 and is pivotal about an axis that is parallel to an axis of rotation of the cam 32. Leaf spring 35 is fixed to the follower 36 and is compressible against a front face of the piston 20 (as illustrated in FIG. 6B) or, alternatively, against the upper pin 37.

When the cam 32 is rotated in the direction of arrow 81 of FIG. 6B (counterclockwise in the view of FIG. 6B), and the leading face 33 contacts tip 34, the rotational force of the cam 32 causes force to be applied on the follower 36 in the direction of arrow 82 of FIG. 6B. This rotational force is translated to the rod 31 that is embedded within the follower, and from the rod 31 to the walls 26 of the piston 20, and to the push plate 24. As a result, the push plate 24 is advanced forwards radially within tubular body 14, as the elevational region 22 is advanced within internal space 12. Continued application of pressure from cam 32 causes the entire follower 36 to descend within feeder 10, and, correspondingly, causes the push plate 24 to continue to advance within tubular body 14. The point of contact of the leading face 33 and tip 34 correspondingly rotates. This may be viewed through comparison of the location of rod 31 in FIG. 11A, in which the piston 20 is in the most retracted position, versus FIG. 11B, in which the piston 20 has been actuated to the midpoint of the potential advancement. When the piston 20 has advanced to the furthest point of advancement, as shown in FIG. 11C, the follower 36 is near the very bottom of the interior space 12 of the feeder 10.

The degree of advancement of the piston 20 may be controlled through control of the angular rotation of the camshaft. As a result, the actuator may be configured to displace the piston 20 in metered increments, and, correspondingly, to dispense a metered amount of food product ingredient from the tubular body 14.

The actuator may be reset by rotating the cam 32 in the opposite direction (clockwise in the view of FIG. 6B). When the cam 32 is rotated in the opposite direction, the cam 32 and follower 36 operate in the manner of a classic snail cam mechanism. Specifically, follower 36 is raised and lowered along the outer radius of the cam 32, and “drops” when the cam 32 is rotated past the leading face 33. The rise of the follower 36 is counterbalanced by tensioning of leaf spring 35. When the follower 36 drops, the release of the tension of the leaf spring 35 helps ensure that the follower 36 returns to the same position as it was prior to being raised. As a result, the raising and lowering of the follower 36 has no bearing on the positioning of the piston 20 within the tubular body 14. The piston 20 is thus placed again in position to continue dispensing the ingredient, upon rotation of the camshaft in the initial direction.

It should be noted that, when the feeder 10 is configured in a standalone manner, as illustrated in FIGS. 6A and 6B, there is no particular need to reset the actuator. This is because, following every metered displacement of the piston 20, the cam 32 remains in contact with tip 34 and in position to continue displacing piston 20. Resetting the actuator is useful, however, in embodiments in which multiple feeders 10 share a common crankshaft, as will be described further herein.

FIG. 9A illustrates a close-up view of the connection point between piston 20 and tubular body 14. A stop mechanism 50 may be provided, e.g., for preventing unintentional withdrawal of the piston 20 from the receiving tubular body 14. The stop mechanism 50 is configured for engaging the receiving tubular body 14 with the piston 20. The stop mechanism 50 arrests the receiving tubular body 14 when the piston 20 reaches a fully retracted position.

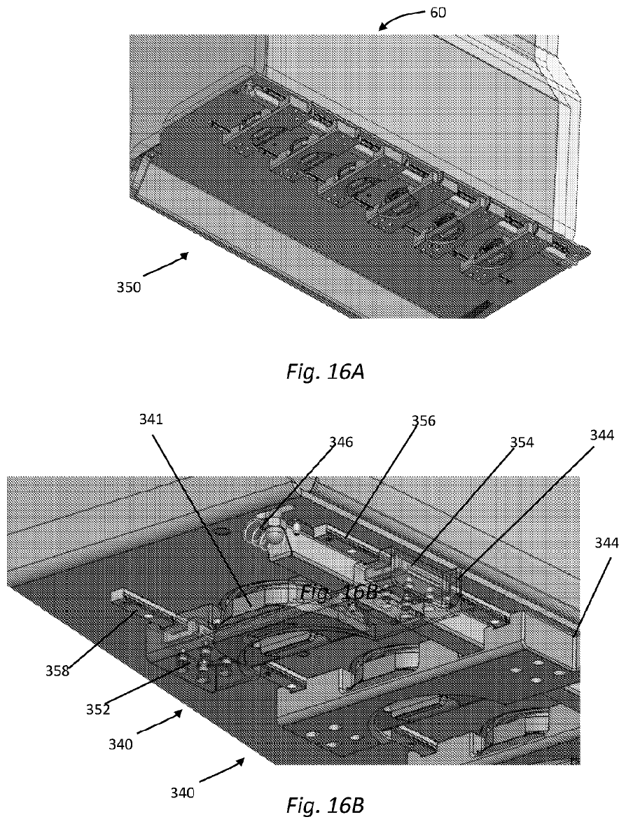

In the mechanism for loading the tubular body 14 described in FIGS. 14A and 14B, a container 40 is inserted into the dispensing end 18 of the tubular body 14. In such embodiments, it is never necessary to withdraw the piston 20 from the tubular body 14, not even to load a container 40. Accordingly, the stop mechanism 50 is configured as a tab, to ensure that, when the piston 20 is retracted, that the piston 20 is not removed entirely from tubular body 14. In another possible mechanism, illustrated in FIG. 9B, a container 40a is inserted into the tubular body 14a from retracted end 16a. In such embodiments, the piston 20a is removed from the tubular body 14a. In such a mechanism, the stop may be replaced with an openable locking mechanism 50a. Clasp 52a is configured to releasably arrest latch 51a, located at a front end of the piston 20.

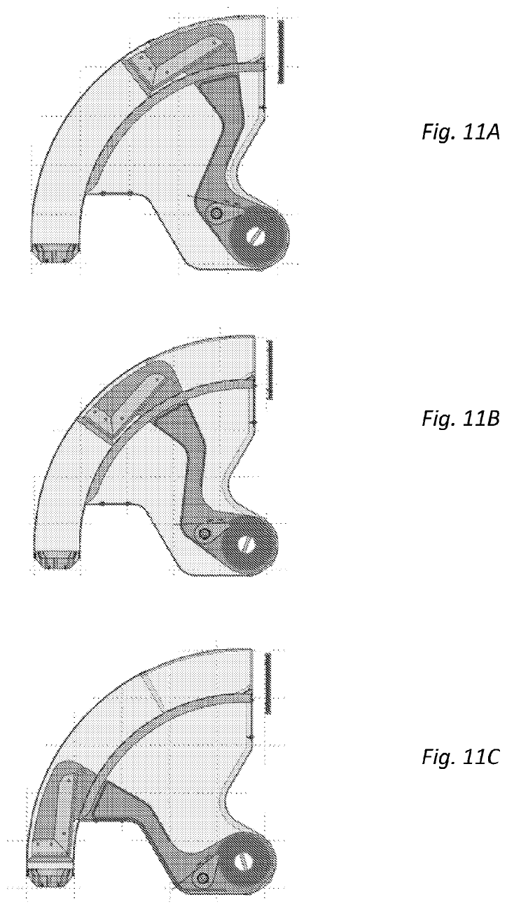

FIG. 10 illustrates a close-up view of the dispensing outlet 18. Dispensing cap 44 is inserted into the dispensing outlet 18, through any suitable mechanism, such as a snap fit. The container 40 has a dispensing nozzle 42. The dispensing nozzle 42 may be securely and removably fixed, in true position articulation, within opening 45 of the dispensing cap 44. The dispensing nozzle 42 may be a substantially rigid element and comprise a positioning collar for arresting by the opening 45 of dispensing cap 44. The opening 45 may have a keyhole shape, with a wider insertion opening and a smaller fixing opening configured for arresting the positioning collar of the dispensing nozzle 42.

The specific configuration of the dispensing nozzle 42 may vary depending on the type of food ingredient or material that is dispensed from the feeder 10. In one preferred embodiment, the food ingredient is a food paste or paste-like material. Advantageously, in such embodiments, the viscosity of the paste is sufficient to ensure that the paste does not exit the nozzle 42, even when the nozzle 42 is oriented in a downward position, until the feeder 10 is actuated. In addition or in the alternative, the feeder 10 may be used to dispense liquids or granular solids, so long as the nozzle 42 is equipped with a suitable valve to ensure that only the desired volume of ingredient is dispensed.

As described above, the feeder 10 may be configured as an independent structure, for dispensing a single type of food product ingredient. This structure alone has various advantages. In particular, the camshaft and the dispensing outlet 18 are substantially coplanar, and the push plate 24 is in a plane that is above the plane of the camshaft and outlet. As a result, this arrangement is particularly suited for a compact three-dimensional arrangement of the feeder, specifically one having limited height.

Additional space-saving advantages may be realized when the feeder 10 is arranged as an array of feeders 10 sharing a common camshaft, as illustrated in FIG. 12.

Referring now to FIG. 12, an array 60 may include a plurality of feeders 10a-10f arranged colinearly. The array 60 may be configured within a cooled ingredient storage portion of a robotic chef. This ingredient storage section may include, for example, cooled air inlet 72 and warm air outlet 74.

FIG. 13 illustrates a motor for concerted actuation of each of the feeders 10a-10f. The motor includes motor drive 62, transmission 63, and camshaft 65. Through the transmission 63, rotation of the motor drive 63 causes rotation of the camshaft 65. The cams 32a-32f of each of the feeders 10a-10f are attached to the camshaft 65 at rings 64. Notably, the cams are affixed to the camshaft 65 at an angular offset. This angular offset may be set according to the number of cams that are configured around the camshaft 65. In the illustrated embodiment, the six cams are offset at 60 degree angles, so that the entire 360 degree range of the camshaft may be utilized. For example, cam 32a may be configured in a dispensing position (contacting the tip of the corresponding follower) when the crank is at angles 0° to 60°; cam 32b may be in a dispensing position from angles 60° to 120°; cam 32c, from angles 120° to 180°; cam 32d, from angles 180° to 240°; cam 32e, from angles 240° to 300°; and cam 32f, from angles 300° to 360°. Obviously, if there are fewer or more than six cams, the offsets may be set to different values, so as to utilize the entire angular range of the camshaft.

Preferably, the angular range of the arc of each receiving tubular body 14 is no greater than the angular offset between each cam 32 on the camshaft 65. Thus, if the angular offset is 60°, and the arc of each receiving tubular body 14 is also 60°, then it is possible to empty each tubular body 14 without actuating a different cam 32. By contrast, if the angular offset is less than 60° while the arc of the tubular body is 60° or more, then emptying one tubular body 14 would not be possible without unintentionally also dispensing some food product from a different tubular body. If the angular offset is greater than the arc of the corresponding tubular body, it would be possible to empty the tubular body as desired, although some of the camshaft 65 would not be utilized.

Using the shared camshaft, it is possible to actuate and reset the feeders sequentially, in order to dispense any combination of the ingredients, and in any order.

By way of example, suppose that it is desired to output three ingredients, which are stored in feeders 10a, 10b, and 10f. Further suppose that each of the feeders are full, and that the angular offset of each cam is 60 °C. Furthermore, suppose that it is desired to extrude a volume corresponding to one-twelfth ( 1/12) of the contents of each container 40 from its respective feeder 10. This one-twelfth corresponds to 5 degrees of rotational arc. Accordingly, in a first step, the camshaft is rotated backwards until cam 32a is adjacent to the tip of the corresponding latch. As discussed above, the backwards rotation merely raises and lowers the latches, with the assistance of the leaf springs, but does not change the position of the pistons. The camshaft is then advanced forwards 5°. This causes the desired amount of raw food product to be extruded from feeder 10a. Because the cams of the other feeders are not adjacent to the corresponding latches, nothing is extruded from those feeders. Then, the camshaft 65 is rotated backwards until it reaches the 60° mark. Camshaft 65 is rotated forwards 5°, thereby extruding the food product from feeder 10b. Camshaft 65 is rotated backwards once again until it reaches the 300° mark, and then rotated forwards 5°, to extrude the food product from feeder 10f.

The array 60 may be equipped with a controller (not shown). The controller not only controls the operation of motor 62 for forwards and backwards movement, as discussed, but may also have a memory. This memory, inter alia, may record the prior actuations of each feeder 10, to ensure that the camshaft 65 is set to the right angular location in order to effect subsequent actuations of that feeder. Thus, in the example given above, should it be desired to dispense another volume of the ingredient from feeder 10a corresponding to 5° of angular extent, the controller causes motor 62 to rotate the camshaft 65 backwards until it reaches the 5° mark, and then forwards from the 5° mark to the 10° mark. In addition or in the alternative to the mechanism described above, a load cell or other weight sensor may also be used to track either the volume of dispensed ingredient or the volume of remaining ingredient. The controller or other suitable sensor may likewise be used to track when a feeder is empty, such that the container needs to be replaced.

FIGS. 14A-14B illustrate a process of replacing and loading a new container 40 into a respective feeder. In the illustrated embodiment, feeder 10b is in the array 60 of FIG. 12. As shown in FIG. 14A, a user grasps the handle 56b of feeder 10b. Feeder 10b, which is arranged on a hinge, is withdrawn downwards and backwards. This exposes the dispensing cap 44b. The piston, which may have been previously advanced to its furthest point of advancement, falls backwards due to gravity. The user removes the dispensing cap 44b from the tubular body 14 (for example, by squeezing flexible ends of the dispensing cap 44b to release the snap fit). The user then removes the nozzle of the used container from the opening of the dispensing cap, securely places the nozzle of the new container into the opening of the new dispensing cap, loads the new container into the dispensing end of the tubular body, and secures the dispensing cap into the tubular body.

Returning to FIG. 5A, the controller is configured to control movement of the raw food platform 224 axially between a loading position, in which the platform 224 is provided below a dispensing outlet 42 of a respective feeder 10, to thereby receive an amount of the raw food material, and a discharge position in which the platform 224 is adjacent to a cooking surface of a respective cooker, to enable discharging the raw food material onto a region of said cooking surface.

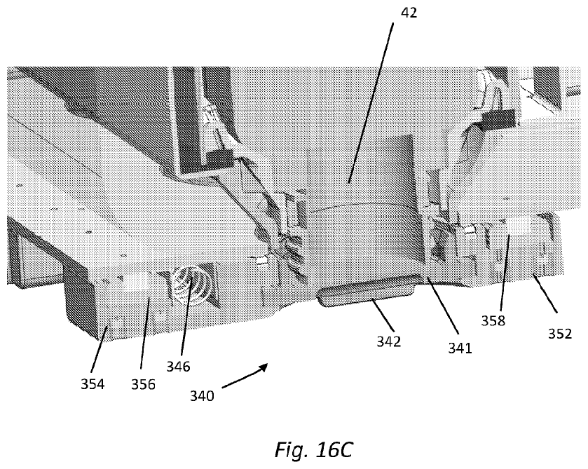

FIGS. 15-19H describe the operation of the platform 224 in the loading position, as well as the function of the actuator 223 which is incorporated in the platform 224.

Referring now to FIG. 15A and FIG. 15B, knife section 250 includes an array of horizontally displaceable knives 240. The knife section 250 is configured directly below the feeder station 60. Each of the knives 240 includes a handle 242, which is oriented toward the front face of the robotic chef. The handle 242 is used for removal of the knife, such as for cleaning or replacement, and is not used in the day-to-day functioning of the robotic chef. Removal of the knife 240 may be accomplished by compression of the leaf spring 248 and removal of the knife 240 from the slot in which it is situated. The knife further includes cutting surface 241, which is situated in the middle of the knife 240. The cutting surface may be, but need not be, sharpened. When, as in some embodiments, the dispensed raw food material is a paste, even a relatively dull knife is sufficient to separate the dispensed paste from the nozzle. The cutting surface 241 is also referred to herein as an “outlet cover,” because, when the cutting surface 241 is in a rest position, it covers the outlet of a corresponding feeder. The outlet covers 241 are movable between a closed state, in which the outlet cover 241 covers the dispensing outlet of a feeder, and an open state, in which the outlet cover 241 does not cover the dispensing outlet.

Each knife 240 is mounted on parallel rails 256, 258, along mounts 252, 254. The knife 240 is slidable along the rails. This sliding is effectuated with a tab 244 and a spring 246. Depression of the tab in one direction may cause movement of the knife 240 along tracks 256, 258, against the force of spring 246. When the tab 244 is released, the release in tension of spring 246 causes the knife 240 to return to its original position.

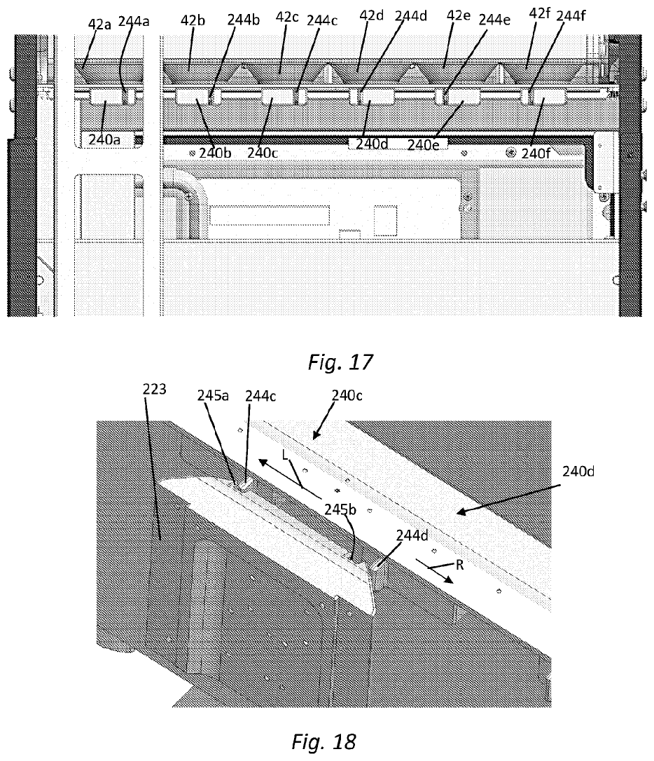

FIGS. 16A-16C illustrate a second embodiment of a knife array 350. Knife array 350 is similar in many respects to knife array 250, and accordingly, similar reference numerals will be used to refer to similar elements, except that they will begin with the number “3.” Each knife 340 is mounted on parallel rails 356, 358, along mounts 352, 354. Each knife 340 is slidable along the rails, with the sliding being effectuated with tab 344 and spring 346. The main difference between this embodiment and the previous embodiment is that the cutting surface 341 is a removable disc that is fitted around the outlet 42 of the nozzle of the corresponding feeder 42. Handle 342 is configured below the cutting surface 341, instead of horizontal to the cutting surface 341. The cutting surface 341 is insertable and removable through any suitable mechanism, such as through a snap-fit or, as in the previous embodiment, through the use of a leaf spring.

The following discussion of the actuation of the knives refers to the embodiment and reference numerals of FIGS. 15A-15B, however, the discussion applies equally well to the embodiment of FIGS. 16A-16C.

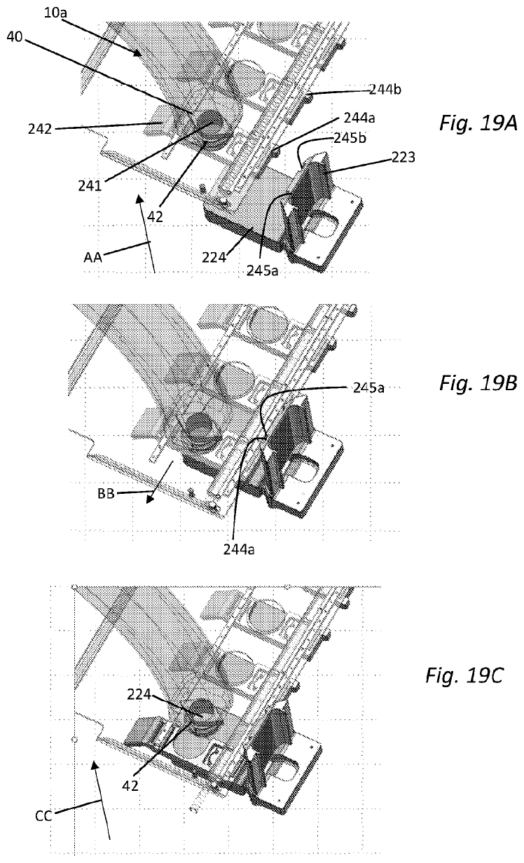

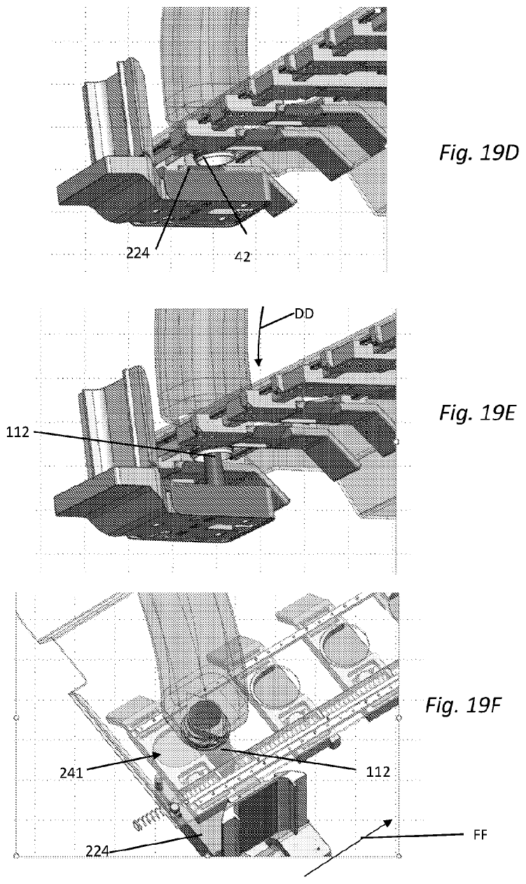

FIG. 17 and FIG. 18 illustrate a setup of the array of knives underneath an array of feeders. Referring to FIG. 17, the array of feeders includes dispensing outlets 42a, 42b, 42c, 42d, 42e, and 42f, arranged linearly. Below each dispensing outlet is a respective knife 240a, 240b, 240c, 240d, 240e, 240f. Each knife has a protruding tab 244 on a rear face thereof. Tabs 244 are oriented differently on different knives in the array. Tabs 244a, 244b, 244c are oriented on the right side of the respective knives 240a, 240b, and 240c. Tabs 244d, 244e, 244f are oriented on the left side of knives 240d, 240e, 240f. The rationale for this difference in orientation will be explained shortly.

FIG. 18 illustrates a process of actuating a knife 240c with the actuator 223. Actuator 223 has one or more slots 245 configured axially above platform 224. In the illustrated embodiment, there are two parallel slots 245a, 245b. Slots 245 are sized to engage the tabs 244. In the illustrated view, actuator 223 has slot 245a fitted around tab 244c. When the slot 245 is engaged with the tab 244, horizontal movement of the platform 224 in a first direction causes displacing of the outlet cover 241 from the outlet 42. In the illustrated example, actuator 223 is moved in the direction of arrow L, toward a periphery of the array, thereby pushing tab 244c in the same direction. Opening of knives 240a and 240b is performed in the same manner, through pushing the tab toward the periphery of the array with slot 245a. By contrast, to open knife 240d, slot 245b is fitted around tab 244d. The actuator 223 is then moved in the direction of arrow R. Opening of knives 240e and 240f proceeds in the same manner. Stated differently, opening of the knife is performed by movement of the knife (and platform) toward the periphery of the array, using the slot that is closer to the periphery, when the tab is oriented closer to the center. To close the dispensing outlet, horizontal movement of the knife (and platform) is performed in an opposite direction, toward a center of the array. Following dispensing of a paste-like raw food material from the dispensing outlet, this movement causes cutting of the paste-like raw food substance from the dispensing outlet onto the platform and closing of the dispensing outlet with the outlet cover.

The advantage of this mechanism is evident through close examination of FIG. 17 and FIG. 18. As seen in FIG. 17, placement of tab 244a towards the center of the robotic chef, and actuation of the tab 244a with slot 245a, leaves sufficient space for the actuator 223 to slide outwards to open the knife 240a, without bumping the actuator 223 into outer walls of the robotic chef. Opening of the knife 240a in this manner also allows the platform 224 to slide directly underneath the dispensing outlet of the feeder 42, to enable dispensing of the raw food material onto the platform 224. The same logic applies with respect to the opening of tab 244f with slot 245b. Furthermore, as seen in FIG. 18, the middle two knives 240c, 240d are opened with the actuator 223 in nearly the same position, one using slot 245a, and the other using slot 245b. As a result, all horizontal space along the array is utilized by the actuator 223 for opening the knives in the array.

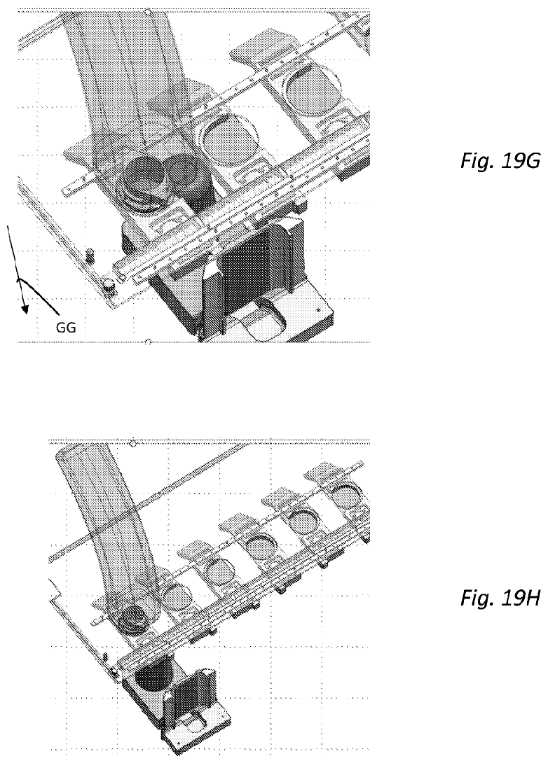

FIGS. 19A-19H illustrate steps in dispensing raw food material from a feeder 10a and onto platform 224.

In FIG. 19A, platform 224 is positioned underneath the array of knives. Raw food material is stored in container 40, within feeder 10a. The nozzle 42 is closed by outlet cover 241 of the knife. In the first stage of actuation, platform 224 is raised in the direction of arrow AA, so as to engage slot 245a around tab 244a.

In FIG. 19B, platform 224 has been raised so that slot 245a surrounds tab 244a. The platform is then moved in direction BB, toward a periphery of the array, so as to open dispensing outlet 42.

In FIG. 19C, the outlet cover 241 has been displaced toward the periphery of the array. The center of platform 224 is aligned below the outlet 42 of the feeder, while the slot 245a and tab 244a are displaced peripherally, to the left of the outlet 42. Optionally, the platform 224 is now further raised, in the direction of arrow CC. This may be done if, for example, the quantity of raw food material to be dispensed onto platform 224 is relatively small.

In FIG. 19D, platform 224 is now in position, ready for raw food material to be dispensed.

In FIG. 19E, the feeder is actuated. Raw food material 112 is dispensed onto platform 224.

In FIG. 19F, the raw food product 112 has been completely dispensed from the feeder. The platform 224 is now moved toward the center of the array, in the direction of arrow FF. This causes outlet cover 241 to pass under, and close, the outlet of dispensing outlet 42. The outlet cover slices the raw food material and separates the raw food material from the dispensing outlet 42.

In FIG. 19G, the outlet cover 241 has completely closed dispensing outlet 42. As a result, the raw food product 112 is now separated from the dispensing outlet 42. Slot 245a is still engaged around the tab 244a. The platform 224 is lowered in the direction of arrow GG, to release tab 244a.

In FIG. 19H, the platform 224 has been lowered, and the dispensing process is complete. The platform 224 is ready to be transported to the cooking station, or to a different feeder for dispensing of additional raw food product.

One advantage of the platform 224, actuator 223, and knife 240 depicted here, is that the same lift system that is used to carry raw food from the feeder to the cooker is also used to actuate the knives. No separate actuator is required for opening and closing the knives. Moreover, the actuator 223 is formed integral with the platform 224 and leg 222, and it does not occupy a significant volume. In addition, the use of a pair of slots 225a, 225b, in combination with differential placement of tabs 244, enables the actuation of all the knives in the array with the same actuator 223, and without requiring any additional horizontal space, as discussed.

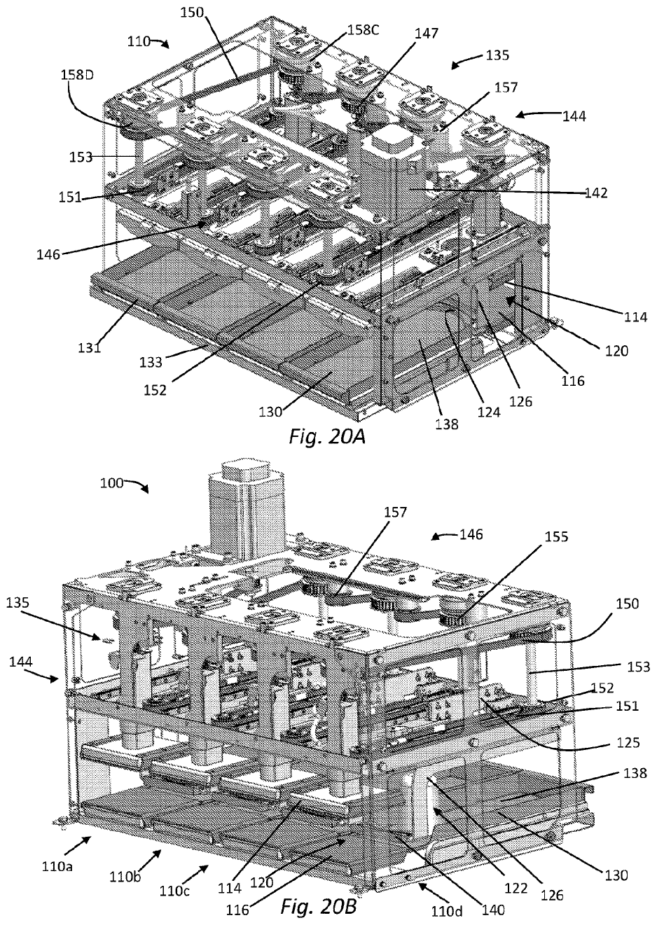

FIGS. 20A-26 illustrate features of the cooking system and methods of use of the cooking system.

As used in the present disclosure, the terms “cooker” and “cooker mechanism” are used interchangeably and refer to a mechanism for preparing a food product. The cooker comprises a bottom heater and a top heater defining therebetween an axially controllable cooking space configured to receive therein an uncooked food item. The cooker further includes a food product dragger that is configured for displacing a cooked food product from the cooking space to a prepared food tray. A driving system selectively controls the cooking space and the food product dragger.

As disclosed herein, a cooker mechanism is structured and operable to receive, on a top surface of the bottom heater, an uncooked food item which is to be shaped and cooked. The uncooked food item may be a patty of any composition deposited or retracted directly or indirectly onto the top surface of the bottom heater. In some configurations, the uncooked food item is received from a deposition unit (such as platform 224) that is external to the cooker. Once the uncooked item is positioned on the top surface of the bottom heater, the top heater is lowered along a vertical axis to press the uncooked product into a disc or a flat shape. While pressing, the food product is heated and cooked. Once the top heater transitions back to its original loading position, the shaped and cooked food item is pushed by the food dragger from the bottom heater to a cooked food tray from which the cooked food product may be retrieved by a user or an operator of the cooker.

As used in the present disclosure, a “cooking system” or a “cooking unit” is a system including more than one cooker, in which all the cookers share the same drive system for controlling the respective top heaters and food draggers.

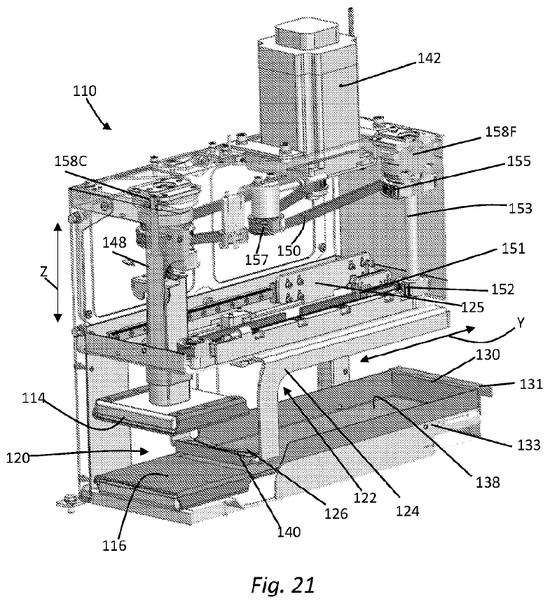

Referring now to FIGS. 20A, 20B, and 21, cooking system 100 includes one or more cookers 110a, 110b, 110c, 110d. The cookers 110a-110d are arranged in a collinear array. Each cooker 110 includes top heater 114 and bottom heater 116, which define therebetween a cooking space 120. Each of the heaters may be heated to a temperature of between 120 °C and 200 °C to cause cooking and/or grilling of the uncooked food item. Depending on the composition of the uncooked food product, the amount of the product placed on the bottom heater 116 and the degree of cooking that is desired, the temperature of the bottom heater 116 and top heater 114 may be varied. The two heaters may or may not maintain the same temperatures.

The heating surface of one or both of the bottom heater 116 and top heater 114 may be flat or patterned. In some embodiments, one or both of the top heater 114 and the bottom heater 116 is fitted with a detachable heating plate, which may be coated with a food-safe, dirt-repellent, non-stick, dishwasher-safe, and/or anti-scratch material.

In some embodiments, one or both of the bottom heater 116 and the top heater 114 are configured with one or more temperature sensors. The temperature sensors may be configured for measuring the external temperature of the food item or an internal temperature thereof. The temperature sensors may be in a form of thermocouples, resistance temperature detectors (RTDs), thermistors, or semiconductor based integrated circuits (ICs).

One or both of the bottom heater 116 and the top heater 114 is axially displaceable to change the distance therebetween; namely, to change the height of cooking space 120. In the illustrated embodiments, the top heater 114 is axially displaceable with respect to the bottom heater 116 along a vertical axis Z, i.e., wherein the length of the axis Z defines the distance between the bottom heater 116 and the top heater 114 or the height of the cooking space 120. The bottom heater 116 is stationary or fixed in position. Theoretically, it is possible to arrange the cooker 110 so that the top heater 114 is fixed and the bottom heater 116 moves with respect to the top heater 114.

The maximum distance between a top surface of the bottom heater 116 (namely a surface facing upwards) and a bottom surface of the top heater 114 (namely a surface facing downwards) defines the maximum height of the cooking space 120. When the mechanism is in a non-operable or idle state, each of the heaters may be positioned at a loading position. In the loading position, the cooking space 120 is at a maximal height, to permit loading of an uncooked food item into the cooking space 120. After insertion of the uncooked food item, when one of the heaters is fixed, e.g., the bottom heater 116, the other heater, e.g., top heater 114, may move along the vertical axis Z in a direction of the fixed heater. The top heater 114 may be lowered to a suitable height, corresponding to the thickness of the uncooked food item. The thinner the food item is, the closer the distance or gap between the surfaces of the heaters may be.

The distance the moving heater travels in a direction of the fixed heater, the temperature of each of the heaters, the contact time period between the heaters and the food item as well as any change in pressure and/or temperature applied to the food item defines a cooking profile. The cooking profile may differ each time the cooker is used.

To accurately adapt the pressure and temperature conditions to the particular food item, the cooker 110 may be provided with a temperature sensor, as discussed above, which is configured to measure a temperature of the food item throughout the cooking session. Based on such thermal measurements, the cooking temperature and/or the contact between the food item and the heaters may be varied to cause more effective cooking or to cause a slower or a limited level of cooking.

The cooker mechanism 100 is equipped with a controller (not shown). The controller is configured to receive data signals corresponding with parameters of one or more of the cooking space drive mechanisms and the dragger drive mechanism (both of which will be described further herein), weight of a food item placed over the bottom heater 116, temperature of the top heater 114 and the bottom heater 116, and optionally temperature of the product undergoing cooking. The controller is set to generate command signals to control operation of one or more of the cooking space drive mechanisms, the food item drive mechanism, temperature of the bottom heater and of the top heater.

Still referring to FIGS. 20A, 20B, and 21, each cooker 110 further includes a food dragger mechanism (hereinafter, “dragger”) 122 and a prepared food tray 130. Dragger 122 includes a dragging surface 124, a mount 125, and arms 126. The dragging surface 124 is sized and shaped to push a food item from the cooking space 120 to the prepared food tray 130. The dragging surface 124 may also be configured in a particular three-dimensional shape, such as a semicircle, in order to shape the food item prior to cooking. The mount 125 is attached to a drive system, whose function will be described further herein. Mount 125 is also attached to two parallel arms 126. The arms 126 are sized and dimensioned such that, on their lower ends, the arms 126 extend around the width of the top heater 114, the bottom heater 116, and the prepared food tray 130. On the upper ends of the arms 126, the mount 125 connects to a drive module for the dragger 122, which, in turn, is powered by the drive system 135 of the cooker.

As seen best in FIG. 21, the prepared food tray 130 includes a removable drawer 131 that is slidably removable from base 133. Drawer 131 includes a prepared food receiving surface 138. Thus, when a prepared food is deposited onto surface 138, a user may open drawer 131 and remove the prepared food therefrom.

In the illustrated embodiment, the heating surface of the bottom heater 116 is coplanar with the surface 138 of the prepared food tray. Advantageously, the dragger 122 is thus able to push prepared food directly from bottom heater 116 to the drawer 131. This allows for smooth and uninterrupted placing and displacing of the food item from the surface of the bottom heater 116 onto the food tray 130. Furthermore, the prepared food tray 130 may be sized and shaped to accommodate one or more prepared food items positioned in a row. The displacement of a cooked food item from the cooking space onto the food tray may be such that any further prepared food item slidingly displaces a previously prepared food item. For example, a first cooked food item may be dragged onto the tray 130, and a second food item is prepared (shaped and cooked as disclosed) while the first cooked food item remains in the tray 130, such that when the dragger 122 pushes the second cooked food item onto the tray 130, the second food item displaces the first cooked food item.

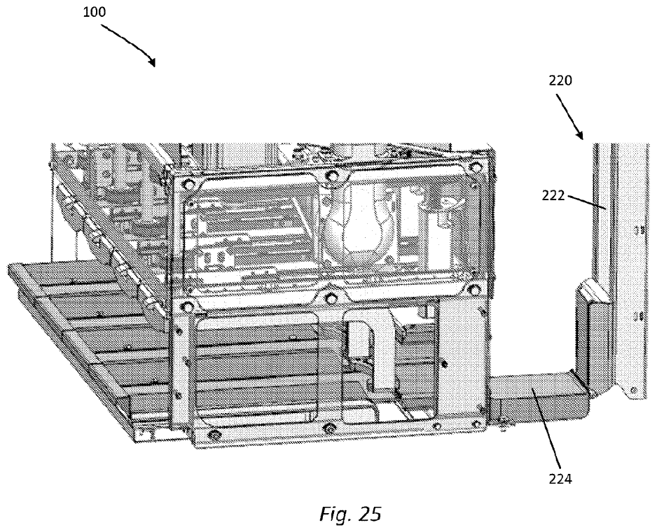

Optionally, the dragger 122 includes a wiper 140 on an opposite side of the dragging surface 124. Movement of the dragger 122 in a first horizontal direction pushes uncooked food from platform 224 (shown in FIG. 25) to the cooking space 120 and pushes a prepared food item from the cooking space 120 to the prepared food tray 130. Movement of the dragger 122 in an opposite horizontal direction causes the wiper 140 to wipe the heating surface of one or both of the bottom heater 116 and top heater 114. The wiper is slidably displaceable over the heating surfaces of the bottom heater 116 and/or the top heater 114, and is used to clear oils and other residues off of those surfaces following cooking of a food item.

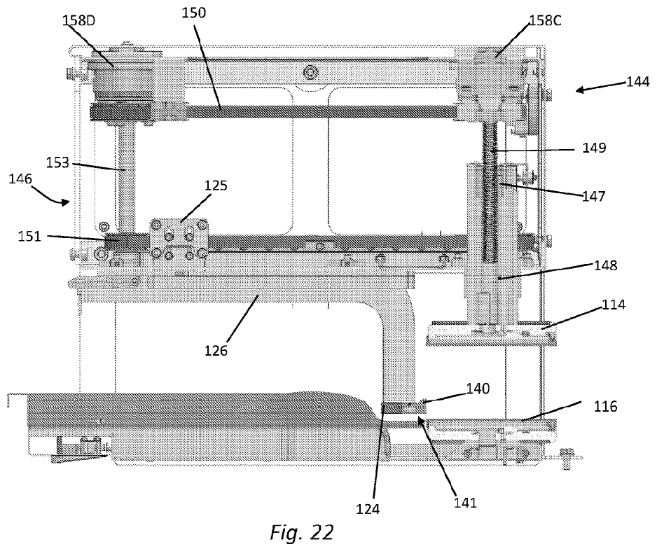

The dragging surface 124 and the wiper 140 may be made of a single molded piece, e.g., of rubber or silicon. The wiper 140 may be detachable from the dragger 122, to enable easy cleaning of the wiper 140. The width of the wiper 140 may be equivalent to the width of heating surfaces of the top and bottom heaters, in order to ensure that the wiper 140 cleans the entirety of those heating surfaces. In a preferred embodiment, and as seen best in FIG. 22, the height of the wiper 140 is greater than the height of the dragging surface 124. In addition, the wiper 140 may include a groove 141 on an underside thereof, as seen in FIG. 22. Advantageously, the flexibility enabled by the groove 141, in combination with the height differential, enables the top heater 114 to lower over the wiper 140 and to “clamp” onto the wiper 140. This clamping enables the wiper 140 to snugly displace over the top and lower heating surfaces.

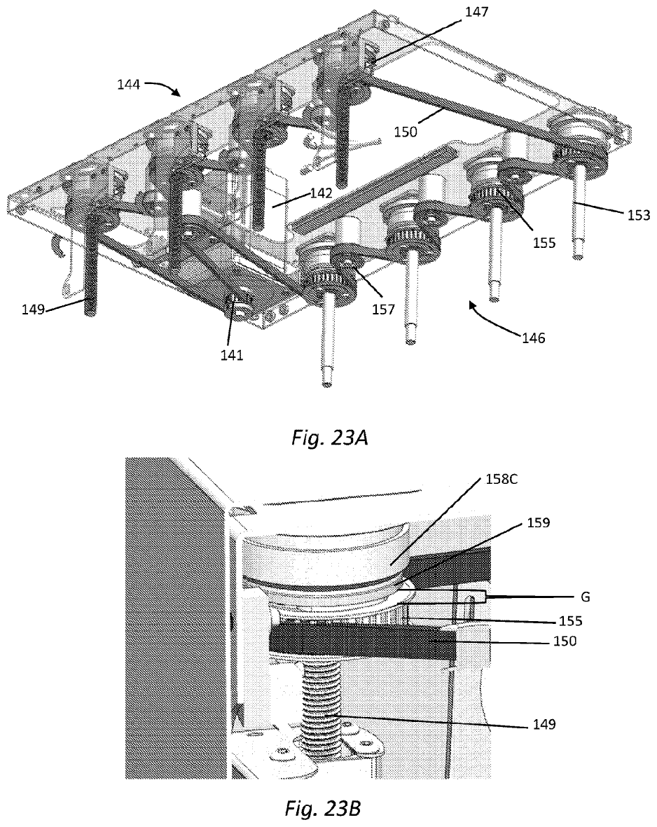

As mentioned above, cooking system 100 includes an integrated drive system 135 for controlling both an axial dimension of the cooking space 120 and a horizontal displacement of the dragger 122. The drive system 135 further includes cooking space drive subsystem 144 and dragger drive subsystem 146. The drive system 135 is illustrated, in various views, in FIGS. 20A, 20B, 21, 22, 23A, and 23B. The drive system includes a drive belt 150, which is powered by motor 142. The motor 142 may be, for example, a stepper motor or a servo motor. The motor 142 may receive instructions from a controller (not shown) to advance the belt 150 in a forward direction or a backward direction (e.g., clockwise or counterclockwise in the view of FIG. 23A).

Belt 150 advances in a loop, starting from motor 142 to motor gear 141, and then sequentially to gears 155 and tension elements 157. When, as in the illustrated embodiments, there are multiple cookers 110 in cooker system 100, the belt 150 first advances through all the gears 155 associated with the cooking space drive 144, and then advances through all the gears associated with dragger drive 146 (or vice versa, depending on the direction of travel of the belt 150).

Each of the gears 155 includes a clutch 158, for selectively connecting and disconnecting shafts from the belt drive 150. The clutches associated with the cooking space drive 144 (“cooking space clutches”) are designated with reference numeral 158C, and the clutches associated with the dragger drive 146 (“dragger clutches”) are designated with reference numeral 158D. In a preferred embodiment, clutches 158 are electromagnetic clutches. The electromagnetic clutches 158 include magnets 159 (shown in FIG. 23B) which are activated by the controller. When the clutches are disengaged, the electromagnets are off, and magnets 159 do not exert a magnetic attraction. In this state, a gap G (shown in FIG. 23B) exists between the magnets 159 and the gears 155. As a result, rotation of the gears 155 by the belt 150 does not affect the magnets 159 or anything mechanically connected thereto. By contrast, when the electromagnets are activated, a magnetic attraction is formed between magnets 159 and gears 155. As a result, the magnet 159 and the gear 155 are mechanically connected, and rotation of the gears 155 causes corresponding rotation of the magnet 159 and everything mechanically connected thereto.

In the cooking space drive 144, the electromagnets 159 are mechanically connected to a cooking space shaft. The cooking space shaft is part of a vertical actuator or “jack mechanism” for raising and lowering the top cooker 114. In the illustrated embodiment, the jack mechanism is a screw jack. The cooking space shaft is screw gear 149, which rotates within traveling nut 147, as best seen in FIG. 22. Traveling nut 147 is attached to housing 148, to which top heater 114 is attached. As a result, rotation of the screw gear 149 in a first direction causes the housing 148 and top heater 114 to rise, and rotation of the screw gear 149 in a second direction causes the housing 148 and top heater 114 to descend.

As may be readily understood by those of skill in the art, alternative jacks or vertical actuators may be contemplated as well. For example, the cooking space drive 144 may include a hydraulic jack.

The cooking space drive 144 is configured for axially displacing the top heater 114 to any desired height. In particular, the top heater 114 may be displaced between a loading position at which the cooking space 120 is maximal, a cooking position at which the cooking space 120 corresponds with the height or thickness of the prepared food item, and a cleaning position at which the wiper 140 displaces through the cooking space 120, snugly between the top heater 114 and the bottom heater 116, for wiping off or removing liquid or solid or fatty residual materials left from a cooking session.

In the dragger drive 146, the electromagnets 159 are mechanically connected to dragger shafts 153. Dragger shafts 153 are connected, at their other end, to a horizontal actuator for the dragger 122. This horizontal actuator includes spur gears 152, which, in turn, are configured to advance dragger belt 151. Thus, when the electromagnet 159 is activated, rotation of belt 150 in a given direction (e.g., clockwise) causes rotation of the dragger belt 151 in the same (clockwise) direction. In addition, as seen in FIG. 22, the arms 126 of dragger 122 are connected, via mount 125, to the dragger belt 151. In sum, when the clutch 158D is engaged, rotation of belt 150 causes rotation of shaft 153, which causes rotation of dragger belt 151, which causes displacement of the dragger mount 125 which causes advancement or retraction of dragger 122. The horizontal actuator is configured to displace the dragger 122 between a loading position, in which the dragger 122 extends external to and behind the cooking space 120, an intermediate position in which the dragger is located within the cooking space 120, and an advanced position in which the dragger 122 is located at least partially above the prepared food tray 130. The uses of these different horizontal positions will be discussed further herein.

As may be readily understood from the foregoing discussion, the drive system 135 may be utilized for achieving movements of the top heater 114 and the dragger 122 at the same time. However, these coinciding movements are necessarily limited based on the direction of movement of belt 150. When clutches 158C, 158D are activated, rotation of the belt drive 150 in a first direction causes rotation of the cooking space shaft 149 and the dragger shaft 153 in the same first direction, and rotation of the belt drive 150 in the opposite direction causes rotation of the cooking space shaft 149 and the dragger shaft 153 in the same opposite direction. For example, clockwise movement of belt 150 may cause downward movement of a top heater 114 and forward movement of dragger 122. Similarly, counterclockwise movement of belt 150 may cause upward movement of top heater 114 and backwards movement of dragger 122. Thus, it is possible for the top heater 114 and dragger 122 to move simultaneously, but only in one combination of movements. More commonly, for purposes of convenience and ease of coordination, the top heater 114 and dragger 122 may be configured to move at different times, as in the examples described further herein.

It may also be readily understood based on the foregoing discussion that, when the cooker system 100 includes multiple cookers 110 arranged colinearly (as in the system 100 depicted in FIGS. 20A, 20B, and 21), that the drive system 135 may be engaged to implement simultaneous movements of top heaters 114 and draggers 122 in each of the cookers 110. Again, the only limitation is that belt 150 may rotate only one direction at a time. Thus, for example, if all the screw gears 149 are threaded in the same way, it is possible to lower the top heaters 114 in cookers 110a and 110b at the same time, because the lowering of both top heaters 114 is performed by rotating the belt in the same direction. However, it is not possible to lower a top heater 114 of cooker 110a while raising the top heater 114 of cooker 110b, because these movements would require two opposing movements of the belt 150. The same analysis applies with respect to movement of the draggers 122 forward or backward at the same time as lowering or raising the top heaters 114.

On the flipside, the disclosed drive system 135 enables significant space savings and economies of scale. The same drive belt 150 is able to cause both vertical movement of the top heater 114 and horizontal movement of the dragger 122. Furthermore, the same drive belt 150 may be used to actuate multiple cookers 110 in an array, in which the cookers 110 are aligned along an axis that is perpendicular to an axis of movement of each dragger 122. In the illustrated embodiment, there are four cookers 110 in the array; however, as is apparent, there is no maximum in the number of cookers 110 that could be included in the array. The disclosed drive system 135 thus enables achievement of a high throughput of hamburgers or patties, in an automated fashion, in a relatively small space.

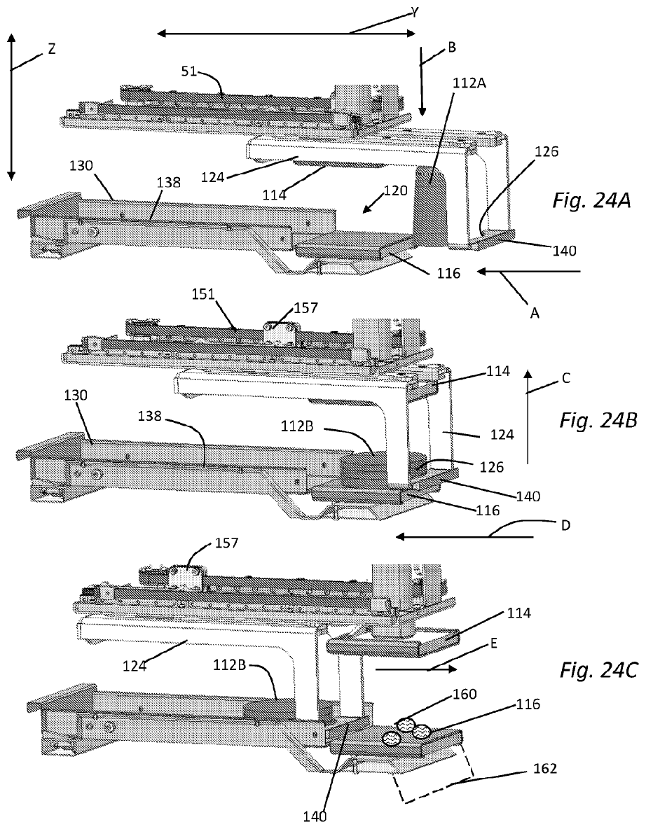

FIGS. 24A-24C and FIG. 25 illustrate a process of operation of a cooker 110, according to embodiments of the present disclosure. The process involves sequential operation of the drive belt and the clutches, with the controller, so as to generate a specific sequence of movements in both the top cooker 114 and in the dragger 122. These movements are effectuated in the Y axis (for the dragger 122) and in the Z axis (for the top cooker 114). These movements include: retraction of the dragger 122 to the loading position; advancement of the dragger 122 from the loading position to the intermediate position to thereby load an uncooked food product into the cooking space 120; axial lowering of the top heater 114 relative to the bottom heater 116 to thereby press the uncooked food product; following cooking of the food product, axial raising of the top heater 114 relative to the bottom heater 116; and horizontal displacement of the food product to the prepared food tray 130 with the dragger 122.

In the view of FIG. 24A, an uncooked patty 112A is present behind the cooking space 120. The dragger 122 is in a raw food item “loading position,” in which the dragger surface 124 extends outside the cooking space 120.

For purposes of clarity, the platform on which the patty 112A is resting is not shown in FIG. 24A. One possible embodiment of such a platform is illustrated in FIG. 25. In FIG. 25, platform 224 is attached to lift 222. The platform 224 and lift 222 are integrated with gantry 220, as described at length above, for bringing raw ingredients from an ingredient storage module to the cooker array. Platform 224 may be provided with a weight measuring unit, such as a load cell, to determine weight of an uncooked food item placed thereover. The measured weight of the uncooked food item may be used to modify a cooking profile. As may be seen in FIG. 25, the platform 224 may be approximately the same width as the bottom heater 116 and as the dragging surface 124. In addition, the horizontal extent of arms 126 enables the dragging surface 124 to be oriented behind the uncooked food 112A and platform 224, so as to enable the dragger 122 to move uncooked food 112A from the platform 224 to the bottom heater 116.

Still referring to FIG. 24A, following delivery of the uncooked food 112A to the space between the dragger 122 and the cooking space 120, the drive system 135 actuates the dragger 122 to push the uncooked food 112A in the direction of arrow “A,” to the cooking space 120. The cross-sectional shape of the dragger 122 (e.g., semicircular) may also impart a shape to the uncooked food 112A. At this point, the top heater 114 is in the loading position, with maximal height between the top heater 114 and bottom heater 116. The drive system 135 actuates the top heater 114, to lower the top heater 114 in the direction of arrow “B.” The top heater 114 is lowered to a cooking position, at which it is contacting, or even compressing, the uncooked food 112A. The height of the cooking space 120 thus corresponds to the height of the food item. Heat is applied to the food item at both the top heater 114 and the bottom heater 116 to thereby cook the food item.

Referring now to FIG. 24B, the cooker 110 has finished cooking the food item, which is now designated with reference numeral 112B. The controller operates the drive system 135 to cause the top heater 114 to rise in the direction of arrow C. The controller then operates the drive system 135 to cause the dragger 122 to move in the direction of arrow “D,” thereby pushing the cooked food item 112B from the bottom heater 116 to the prepared food tray 130.

Referring now to FIG. 24C, the cooked food item 112B is now on the tray 130, waiting for the user to retrieve it. At this point, oil and other food residue 160 remains on the bottom heater 116. In addition, oil may be adhered to the cooking surface of the top heater 114. In order to remove the oil 160 from the top heater 114 and bottom heater 116, the wiper 140 is passed through the top heater 114 and the bottom heater 116. Specifically, the drive system 135 is operated to drive the dragger 122 backwards, in the direction of arrow E, until the wiper 140 is configured over the edge of bottom heater 116. The drive system 135 then operates to lower the top heater 114 to a cleaning position, in which the gap between the top heater 114 and bottom heater 116 is such that the wiper 140 is able to displace through the cooking space 120 snugly between the bottom heater 116 and top heater 114, thereby guiding residue 160 off of the cooking surfaces and into oil tray 162. The cooker 110 is now in position to receive a new uncooked food item 112A.

This method of operation described in FIGS. 24A-24C with reference to a single cooker may be utilized to prepare multiple food products simultaneously in an array of cookers 110. Each cooker 110 comprises a separate bottom heater 116, top heater 114, prepared food tray 130, and dragger 122, and wherein the cookers 110 in the array share a common drive system 135 for selectively controlling an axial dimension of each cooking space 120 and a horizontal displacement of each dragger 120, wherein the common drive system comprises a belt drive 150. A plurality of cooking space shafts 149 are rotatable by the belt drive 150, each cooking space shaft 149 configured to control a height of one cooking space 120. For each cooking space shaft 149, a cooking space clutch 158C is configured for selectively connecting and disconnecting the cooking space shaft 158C from the belt drive 150. A plurality of dragger shafts 153 are rotatable by the belt drive 150. Each dragger shaft 153 is configured to control a horizontal displacement of a single dragger 122. For each dragger shaft 153, a dragger clutch 158D is configured for selectively connecting and disconnecting the dragger shaft 153 from the belt drive 150. The method includes operation of the belt drive 150 and the clutches 158C, 158D, such that, for each cooker 110, the belt drive 150 rotates the cooking space shaft 149 and dragger shaft 153 at different times.

The drive system 135 described herein may be implemented independently of the cooking system 100, and incorporated into any system for which it is desired to implement axial movement of one element and linear movement of a second element. In such systems, what was described herein as the “cooking space drive” may be described more generally as an “axial drive,” including axial movement shafts and axial movement clutches, etc., and what was described as the “dragger drive” may be described more generally as a “linear drive,” including linear movement shafts, linear movement clutches, and a linear actuation belt corresponding to the dragger belt. The drive system may include an array of paired axial movement shafts and linear movement shafts, and the controller may be configured to control operation of the belts and clutches such that, for any given pair, only one type of shaft (axial or linear) is rotated at any given time.

Advantageously, the dragger 122 serves multiple functions. In particular, the dragger 122 is used for all movements along the Y-axis. These include: transporting raw food from the platform 224 to the cooking space 120; transporting cooked food from the cooking space 120 to the prepared food tray 130, and wiping the cooking space 120 in a backwards movement, when preparing for transport of an additional quantity of raw food.

In addition, the dragger 122, platform 224, and their corresponding drive systems, are aligned so as to enable easy transfer of material from one to the other. In particular, the dragger 122 is mounted on parallel arms 126. In addition to defining a space therebetween for the dragger 122 to slide behind the top heater 114, the arms 126 define a space underneath. When the platform 224 with raw food product is lowered to be parallel to the cookers, and then moved laterally behind a particular dragger, the raw food product on platform 224 slides laterally under arms 126.

For example, comparing the view of FIG. 24A with the view of FIG. 25, it is possible to imagine lift leg 222 behind the dragger 122, while the raw food on the platform 224 is in front of dragger 122. Also, the dragger surface 124, platform 122, and cooking surface are all approximately the same width. The dragger 122 is thus configured to drag all of the raw food material deposited onto the platform 224 onto a respective cooking surface. These interlocking mechanisms enable improved efficiency and overall reduction of space.

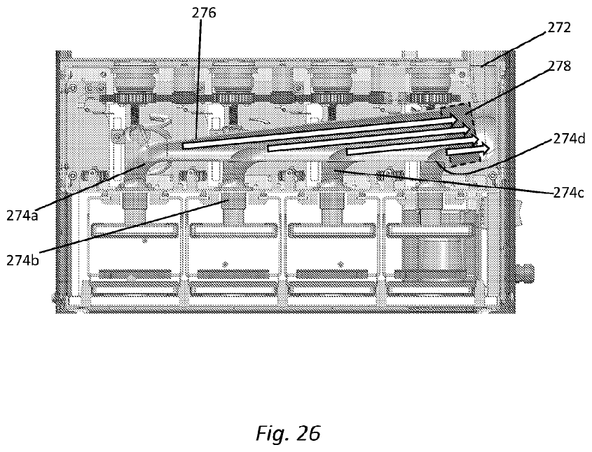

Referring now to FIG. 26, when the cooker system 100 includes an array of cookers 110, it is necessary to ensure that exhaust is properly removed from the cooking spaces 120. For purposes of conservation of space, it is preferable for all of the exhaust to be concentrated into a single exhaust pipe, In addition, for the sake of comfort of the users, exhaust is preferably piped through the top of the robotic chef. In order to enable all these functions, a specially designed exhaust system is utilized, as displayed. Each cooker includes, respectively, an exhaust outlet 274a, 274b, 274c, 274d, at or adjacent to the top heater. These exhaust outlets feed to a shared horizontal section of the exhaust pipe 276. Horizontal exhaust pipe 276 is generally of a conical cross section. The diameter is relatively narrow on one end, and increases in cross sectional area from a first end of the coplanar array to a second end of the coplanar array, from right to left in the view of FIG. 26, as the exhaust of more cookers is added. A fan 278, whose location is schematically indicated, pumps the exhaust from each of the cookers into a vertical section of the exhaust pipe 272, which is on a periphery of the robotic chef. Vertical exhaust pipe 272 brings the exhaust upward to chimney 270. As seen in FIG. 3, the chimney 270 is generally located on an opposite side of the robotic chef relative to electrical box 290 and the inlet air of the cooling system 280. This is advantageous for ensuring that the heat of the exhaust pipe 272 does not damage the electrical circuits or the cooling system.

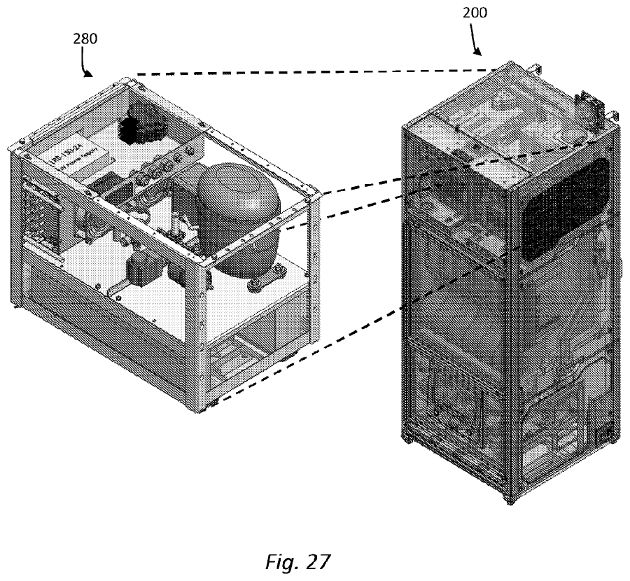

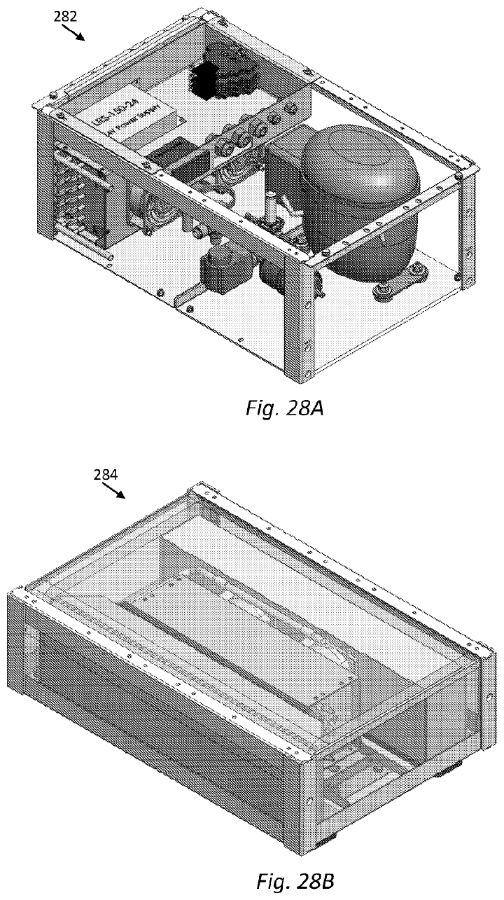

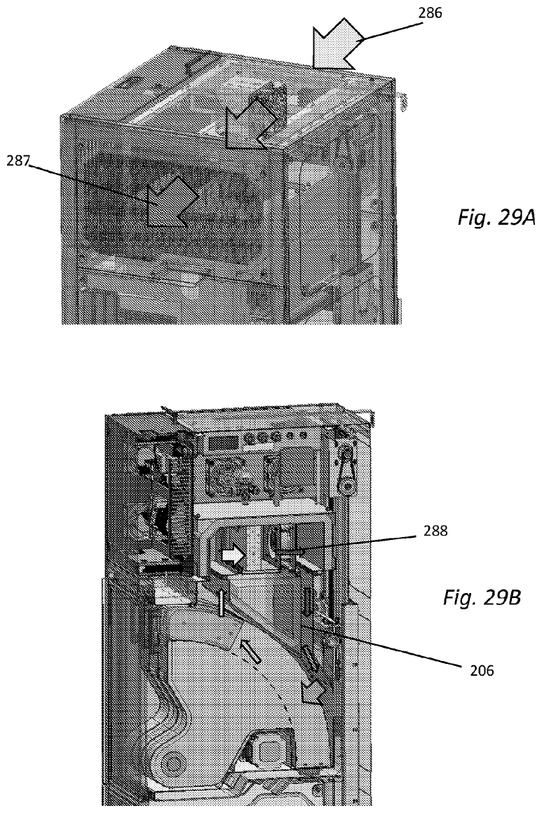

Referring to FIGS. 27, 28A-B, and 29A-B, cooling system 280 is included at an upper portion of the robotic chef 200. The cooling system 280 generally includes an upper, hot zone 282, and a lower, cool zone 284. Generally, hot air proceeds along path 286 and is vented out of the robotic chef through vent 287. Cold air recirculates in the cooling zone 206 along path 288.

As mentioned previously, the robotic chef is controlled by a controller. The controller may include a memory and a processor. The memory may be a non-transitory computer-readable medium that contains instructions, that, when executed by the processor, cause performance of the various steps described herein for the preparation of a food product.

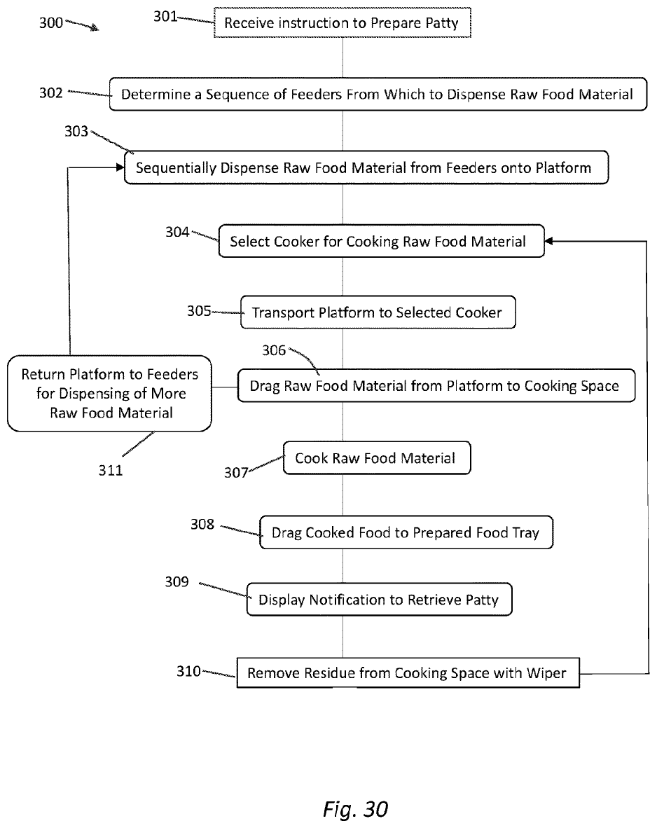

One sequence of such steps for preparation of a food product is illustrated in FIG. 30. In step 301, the controller receives an instruction to prepare a patty. The user may specify a particular weight of the patty and particular ingredients to be included in the patty. In step 302, the controller determines a sequence of feeders from which to dispense raw food material, based on the instructions from the user. At step 303, the controller directs the gantry 220 and the motor of the feeder array 60 to operate in sequence to first open a respective feeder, and then to dispense the desired amount of raw food product from the feeder. The load cells in the platform may be used to confirm that the desired weight of each product was properly dispensed.

At step 304, the controller selects a cooker for cooking the raw material, based on which cooker in the array is available for cooking a new food product. At step 305, the controller directs the platform to be transported to the appropriate cooker. Prior to arrival of the platform, the dragger of that cooker is already in position behind the cooking space.

At step 306, the controller instructs operation of the cooker drive system, so that the dragger drags the raw food material from the platform to the cooking space of the cooker, optionally, while shaping the raw food material. With the platform no longer needed adjacent to the cooker, at step 311, the controller may instruct the gantry to raise the platform back to the level of the feeders, to be prepared for dispensing of more raw food material.

At step 307, the controller further provides the cooker with instructions to cook the raw food material. These instructions include operation of the cooker drive system to lower the top cooker onto the raw food product, supply of heat to the top and bottom cookers, and operation of the fan in order to remove exhaust from the cooker.

At step 308, the controller instructs the cooker drive system to operate the dragger, so as to drag the cooked food to the prepared food tray. At step 309, with the cooked food in the prepared food tray, the controller causes display of a message on the user interface, indicating that the cooked patty is ready to be retrieved.

At step 310, the controller instructs the cooker drive system to reverse the direction of the dragger, and lower the top cooker to a cleaning height, so as to remove residue from the cooking space with the wiper. The cooker is now available for selection again by the controller for cooking of a new patty.

Throughout operation of steps 306 to 310, steps 302 to 305 may be repeated. This enables the platform and lift system to be used to gather raw food material for a new patty, while one or more patties are already cooking.

The system and method described herein may be used to manufacture a high throughput of patties, utilizing a minimum of space. In exemplary embodiments, the system 200 may manufacture approximately 80 patties per hour. The only operator involvement required is to replace the containers of raw food material when they are empty, as well as to open the prepared food trays for removal of the cooked patties.

1.-19. (canceled)

20. A robotic chef, comprising:
a feeder station comprising one or more feeders, each feeder comprising a dispensing outlet and configured to dispense an amount of a raw food material;
a cooking station comprising one or more cookers adapted for shaping and cooking the raw food material, wherein the cooking station is axially above or axially below the feeder station;
a lift configured with a raw food platform; and
a controller configured to control movement of the raw food platform axially between a loading position, in which the platform is provided below a dispensing outlet of a respective feeder, to thereby receive an amount of the raw food material, and a discharge position in which the platform is adjacent to a cooking surface of a respective cooker, to enable discharging the raw food material onto a region of said cooking surface.

21. The robotic chef of claim 20, wherein the feeder station comprises at least two feeders arranged in a coplanar array, and the cooking station comprises at least two cookers arranged in a coplanar array, and the lift comprises a horizontal track, so that the lift is configured to receive raw food material from any feeder in the feeder array and to deliver the raw material to any cooker in the cooker array.

22. The robotic chef of claim 20, wherein each feeder comprises a horizontally displaceable knife, wherein the knife comprises an outlet cover that is moveable between a closed state, in which the outlet cover covers the dispensing outlet, and an open state, in which the outlet cover does not cover the dispensing outlet, and wherein the lift includes an actuator for displacing the outlet cover from the closed state to the open state.

23. The robotic chef of claim 22, wherein, when the outlet cover returns from the open state to the closed state, and raw food material is extending from the dispensing outlet, the outlet cover is configured to slice the raw food material and separate said raw food material from the dispensing outlet.

24. The robotic chef of claim 22, wherein the knife is spring-biased toward the closed state.

25. The robotic chef of claim 22, wherein the actuator comprises a slot configured on the lift axially above the platform, and wherein the knife comprises a protruding tab that is axially below the outlet cover and horizontally displaced relative to the dispensing outlet, wherein the slot is sized to engage the tab, and wherein when the slot is engaged with the tab, horizontal movement of the platform in a first direction causes displacing of the outlet cover from the outlet, and horizontal movement of the platform in an opposite direction, following dispensing of a paste-like raw food material from the dispensing outlet, causes cutting of the paste-like raw food material from the dispensing outlet onto the platform and closing of the dispensing outlet with the outlet cover.

26. The robotic chef of claim 25, wherein the feeder station comprises at least two feeders arranged in a coplanar array, and wherein the actuator comprises two parallel slots configured to engage the tab, and wherein the controller is configured to select one of the two parallel slots to engage the tab such that opening of the dispensing outlet occurs through a movement of the platform toward a periphery of the array.

27. The robotic chef of claim 20, wherein each cooker comprises a dragger configured to drag the raw food material from the platform to a cooking surface of a respective cooker.

28. The robotic chef of claim 27, wherein the dragger comprises a dragger surface mounted on two parallel arms, wherein the parallel arms define a space therebetween that is sized to permit a top heater of the cooker to pass therebetween, and a space underneath to enable the raw food material to pass underneath when the platform is moved laterally relative to the dragger.

29. The robotic chef of claim 28, wherein the dragger surface, platform, and cooking surface are approximately the same width, so that the dragger is configured to drag all of the raw food material deposited onto the raw food platform onto a respective cooking surface.

30. The robotic chef of claim 20, further comprising an exhaust for venting hot air from the cooking station.

31. The robotic chef of claim 30, wherein the cooking station comprises a plurality of cookers arranged in a coplanar array, and the exhaust comprises a shared exhaust pipe for each of the plurality of cookers, wherein the shared exhaust pipe comprises:
a horizontal section that increases in cross sectional area from a first end of the coplanar array to a second end of the coplanar array; and
a vertical section extending from the second end of the coplanar array to a top of the robotic chef.

32. The robotic chef of claim 20, wherein the feeder station is configured within a cooling zone for maintaining the raw food product ingredients cool, and wherein the lift and platform are outside the cooling zone.

33. The robotic chef of claim 20, wherein the platform comprises one or more load cells configured to measure a weight of dispensed raw food product.

34. A method of preparing a food product with a robotic chef, wherein the robotic chef comprises a feeder station comprising one or more feeders, each feeder comprising a dispensing outlet and configured to dispense an amount of a raw food material; a cooking station comprising one or more cookers adapted for shaping and cooking the raw food material, wherein the cooking station is axially above or axially below the feeder station, a lift configured with a raw food platform; and a controller configured to control movement of the raw food platform axially between a loading position, in which the platform is provided below a dispensing outlet of a respective feeder, to thereby receive an amount of the raw food material, and a discharge position in which the platform is adjacent to a cooking surface of a respective cooker, to enable discharging the raw food material onto a region of said cooking surface,, the method comprising:
receiving a user instruction regarding composition of a food product;
actuating the lift so as to place the platform in a loading position beneath at least one feeder;
dispensing raw food material from the at least one feeder;
delivering the platform from the loading position to the discharge position in which the platform is adjacent to a cooking surface of a respective cooker, to enable discharging the raw food material onto a region of the cooking surface;
cooking the raw food product in the cooker; and
dispensing the cooked food product from the cooker to a cooked food drawer.

35. The method of claim 34, wherein each feeder comprises a horizontally displaceable knife, wherein the knife comprises an outlet cover that is moveable between a closed state, in which the outlet cover covers the dispensing outlet, and an open state, in which the outlet cover does not cover the dispensing outlet, and wherein the lift includes an actuator for displacing the outlet cover from the closed state to the open state, and the dispensing step further comprises:
actuating the outlet cover from the closed state to the open state;
dispensing the raw food material from the at least one feeder in the open state; and
returning the outlet cover from the open state to the closed state.

36. The method of claim 35, wherein, when raw food material is extending from the dispensing outlet, the returning step comprises slicing the raw food material and separating said raw food material from the dispensing outlet.

37. The method of claim 35, wherein the actuator comprises a slot configured on the lift axially above the platform, and wherein the knife comprises a protruding tab that is axially below the outlet cover and horizontally displaced relative to the dispensing outlet, wherein the slot is sized to engage the tab, and wherein:
the step of actuating the outlet cover comprises engaging the slot with the tab and horizontally moving the platform in a first direction to thereby cause displacing of the outlet cover from the outlet, and the step of returning the outlet cover comprises horizontally moving of the platform in an opposite direction, following dispensing of the paste-like raw food material from the dispensing outlet, to thereby cut the paste-like raw food substance from the dispensing outlet onto the platform and close the dispensing outlet with the outlet cover.

38. The method of any of claim 35, wherein the feeder station comprises at least two feeders arranged in a coplanar array, and wherein the actuator comprises two parallel slots configured to engage the tab, and wherein the method further comprises selecting one of the two parallel slots to engage the tab such that opening of the dispensing outlet occurs through a movement of the platform toward a periphery of the array.
